(19) United States
(12) Patent Application Publication
(10) Pub. No.: US 2026/0261442 A1
(43) Pub. Date: Sep. 3, 2026

(54) BYZANTINE FAULT TOLERANT BLOCKCHAIN-BASED STATE MACHINE REPLICATION WITH OPTIMISTIC PROPOSALS

(71) Applicant: Unity Chain, Inc., Miami, FL (US)

(72) Inventors: Isaac James Doidge, Queensland (AU); Raghavendra Ramesh, Queensland (AU); Joshua Tobkin, Moorhead, MN (US)

(73) Assignee: Unity Chain, Inc., Miami, FL (US)

(21) Appl. No.: 18/878,437

(22) PCT Filed: Jun. 22, 2023
(86) PCT No.: PCT/US2023/026016

§ 371 Date: Dec. 23, 2024

Related U.S. Application Data
(60) Provisional application No. 63/522,474, filed on Jun. 22, 2023.
(60) Provisional application No. 63/654,272, filed on May 31, 2024.

(51) Int. Cl. H04L 9/00

(52) U.S. Cl. CPC H04L 9/50

(57) ABSTRACT

A system and method for performing consensus operations are described. The method includes receiving a first proposed block in a first phase of a consensus protocol. The method further includes receiving a second proposed block in a second phase of the consensus protocol. The method further includes generating a prepare message including a vote on the first proposed block during the second phase of the consensus protocol. The method further includes receiving a third proposed block in a third phase of the consensus protocol. The method further includes generating a prepare message including a second vote on the second proposed block during the third phase of the consensus protocol. The method further includes committing the first proposed block during the third phase of the consensus protocol.

### RELATED APPLICATIONS

This application claims priority to U.S. Provisional Patent Application Ser. 63/354,272, filed on Jun. 22, 2022, and to U.S. Provisional Patent Application Ser. 63/522,474, filed Jun. 22, 2023, under 35 U.S.C. § 119(e), the entire contents of all of which are hereby incorporated by reference.

### TECHNICAL FIELD

The subject matter described herein relates to consensus blockchain algorithms, systems, architectures, and methods. Specifically, the present disclosure describes byzantine fault tolerant blockchain-based state machine replication with optimistic proposals which results in higher throughput while maintaining the same block finalization latency.

### BACKGROUND

It is well-known that fundamentally blockchains provide trust by marrying fault-tolerant distributed systems design with cryptography, enabling higher transparency and accountability, bringing in greater efficiency by cutting out middleman, and pushing society towards, what is termed as, Economy 2.0.

The heart of these blockchain systems is a consensus protocol and more precisely a state machine replication (SMR) protocol.

In a distributed execution setting and specifically in a blockchain setting having multiple nodes in the blockchain network, a SMR protocol primarily orders transactions, more precisely blocks of ordered transactions, and gives a consistent state sequence for the whole network.

A Byzantine Fault Tolerant (BFT) SMR protocol is an SMR protocol that tolerates a fixed number of Byzantine nodes in the network. Typically, Byzantine nodes are the nodes that could crash or could be malicious and choose not to follow the protocol, but they are assumed not to break cryptographic primitives like signatures.

### SUMMARY

The present disclosure describes a novel BFT SMR protocol by densely chaining PBFT (“Densely Pipelined PBFT protocol” or “DP-PBFT”) instances such that throughput is increased by three times as compared to the standard non-chained PBFT without trading off on block finalization latency.

According to an embodiment of the present disclosure, there is a system and method for performing consensus operations that includes receiving a first proposed block in a first phase of a consensus protocol. The method further includes receiving a second proposed block in a second phase of the consensus protocol. The method further includes generating a prepare message including a vote on the first proposed block during the second phase of the consensus protocol. The method further includes receiving a third proposed block in a third phase of the consensus protocol. The method further includes generating a prepare message including a second vote on the second proposed block during the third phase of the consensus protocol. The method further includes committing the first proposed block during the third phase of the consensus protocol.

### BRIEF DESCRIPTION OF FIGURES

The embodiments will be described in detail with reference to the following drawings in which like reference numerals refer to like elements wherein:

FIG. 1 illustrates a standard Practical Byzantine Fault Tolerant (PBFT) protocol according to an embodiment of the present disclosure.

FIG. 2 illustrates an example of a Densely Pipelined PBFT (DP-PBFT) according to an embodiment of the present disclosure.

FIG. 3 illustrates a consensus process that includes a node timeout according to an embodiment of the present disclosure.

FIG. 4 illustrates a Two-Phase-Commit Blockchain-Based Byzantine Fault Tolerant State Machine Replication Protocol.

FIG. 5 illustrates a byzantine fault tolerant blockchain-based state machine replication with optimistic proposals according to an embodiment of the present disclosure.

FIG. 6 illustrates a performance comparison between embodiments of the present disclosure and other blockchain-based SMR implementations.

FIG. 7 illustrates another performance comparison between embodiments of the present disclosure and other blockchain-based SMR implementations.

FIG. 8 illustrates an example system of components capable of performing instructions for methods of various embodiments of the present disclosure.

### DETAILED DESCRIPTION

Advantages and features of the present invention and a method of achieving the same will be clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Throughout the present specification, like numbers refer to like elements.

Public blockchain networks are revolutionizing modern society by facilitating decentralized, immutable and verifiable data exchange for the first time in human history. These networks fundamentally provide decentralized computation and storage by marrying fault-tolerant distributed systems design with cryptography to enable higher transparency and accountability than traditional centralized computer networks. At the heart of these networks are consensus protocols that enable state machine replication (SMR). A blockchain network is a form of distributed state machine, which is transitioned from one state to another by applying client-submitted instructions called transactions. SMR protocols ensure that every node in the network maintains a consistent state by facilitating their agreement upon the order in which these transactions should be executed. A Byzantine fault-tolerant (BFT) SMR protocol is one that tolerates a fixed number of faulty participants. These faulty participants, termed Byzantine, may crash or otherwise deviate arbitrarily from the protocol, but are assumed to be unable to break cryptographic primitives like signatures. With these definitions in mind, a distinguishment is made between the term blockchain network, as the colloquial name for a network running any type of BFT SMR protocol, and blockchain-based SMR protocol, as a specific type of SMR protocol. blockchain-based SMR protocols differ from other types of SMR protocols by grouping transactions into blocks, with each new block committed by the network referencing the previously committed block as its parent, thus forming the blockchain. This disclosure provides a family of BFT blockchain-based SMR protocols characterized by proposal pipelining, and optimization distinct from the quorum certificate (QC) based pipelining.

Chaining interprets the prepare QC of a block B as a commit QC of B's parent. Because of this interpretation, the block B can be proposed before the commit step on its parent, and hence achieves improved throughput. The communication costs required per block are also reduced by half because of the requirement of only one QC formation per block instead of two. Now that the benefit of chaining is established and because DP-PBFT is a chained protocol, the comparisons are made to the chained SMR protocols.

So far chaining has been employed only in conjunction with the notion of an vote-aggregator. Here the votes are not broadcasted but are only sent to one aggregator, typically the leader of the next round. Then this leader forms a QC and packages this QC along with his proposal. The consecutive honest leader condition of such chaining protocols affect the liveness significantly. DP-PBFT protocol does not fall into these category of chained protocols with liveness issues, mainly because the nodes in DP-PBFT broadcast votes to all other nodes rather than send to one aggregator node. Using broadcast voting, the latency is reduced.

Generally, this disclosure describes densely pipelined practical byzantine fault tolerance. Specifically, densely pipelined practical byzantine fault tolerance using a single-leader Byzantine Fault Tolerant (BFT) SMR protocols characterized by round pipelining facilitated by optimistic proposal. By applying proposal pipelining, that applies quorum certificate pipelining while maintaining the best-case block finalization latency of non-pipelined, vote-broadcast protocols like PBFT. The optimistic proposal pipelining may be utilized in a network composed of N nodes that can communicate over a fully connected network with the availability of standard digital signatures and a public-key infrastructure (PKI) so that the nodes in the network are identified and addressed by their public keys. In some examples, all messages communicating by the network are signed.

As used herein, a node is honest when it behaves as per the specified protocol rules. A Byzantine Failure model where non-honest, or fault, nodes may perform arbitrary state transitions and send any finite set of arbitrary messages with the restriction that they are not able to forge digital signatures of honest nodes even if they collude.

For the sake of explanation, the network is described as having synchronous nodes where there exists a finite and known value φ such that for any run of the system, in any consecutive sequence of φ system states, all nodes take at least one step. In some examples, the network may be an eventually synchronous network that has an initial period of asynchrony where there is no limit on message latencies and where some messages may be lost. After an unknown time period called globally stabilized time (GST), there exists a known value Δ, which is a time-limit on message latencies. For example, round-timers of the nodes are set to expire after a time greater than Δ. A round timer is a timer that counts discrete timer intervals for use with nodes of a blockchain network.

There is a variant of eventual synchrony where after GST, the existence of A is guaranteed but not known. In this case, typically a notion of views is employed where the view timers increase their timeout periods when entering a new view. Finally, after a finite number of steps, a view with its timeout period greater than Δ is reached. Because this procedure is fairly standard, some embodiments of the DP-PBFT protocol use this variant of eventual synchrony.

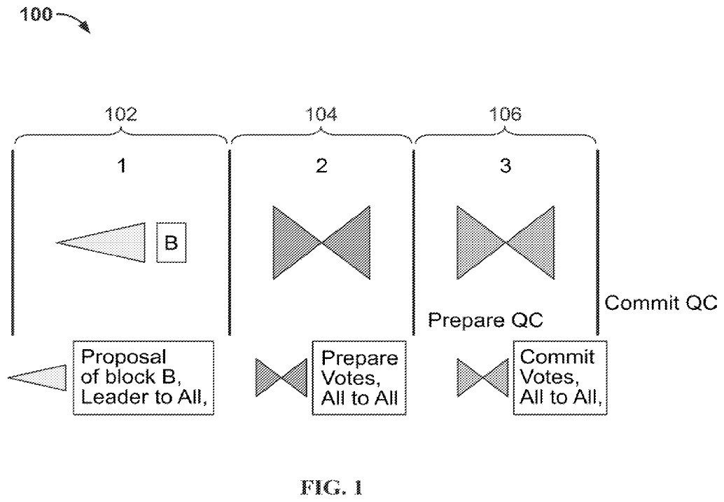

FIG. 1 illustrates a standard Practical Byzantine Fault Tolerant (PBFT) protocol. An example of PBFT is a consensus protocol with 3 steps including a proposal step 102, a prepare step 104, and a commit step 106. For example, a pre-elected leader for the consensus instance proposes (e.g., broadcasts) a block through a signed proposal message in the proposal step 102. In response to receiving a valid proposal from the leader during the proposal step 102, a node enters the prepare step 104 and broadcasts a prepare message indicating a vote or endorsement of the proposal. Nodes wait to receive the prepare messages from other nodes and attempt to form a quorum certificate (QC) of prepare messages, called prepare QC. After forming a prepare QC, the node enters the commit step 106 and broadcasts a commit message (e.g., a second endorsement) that also includes the node's prepare QC. Nodes then wait to receive the commit messages from other nodes. After receiving multiple (e.g., enough to form a quorum) commit messages, it forms a commit QC and then stores the block locally at the node.

In an example, a non-chained or a non-pipelined way of providing state machine replication (SMR) is to connect consensus instances (e.g., the commit QC) for each block. Applying this technique links the consensus of example blocks [B₁, B₂ . . . . Bᵢ] to the parent blocks by connecting the consensus with the previous block such as the parent block of Bᵢ is Bᵢ₋₁, i>1. After performing the proposal step 102, the prepare step 104, and the commit step 106, a PBFT consensus instance is performed for B₁ first, then another consensus instance for B₂, and so on. Using this process, the system has a throughput of 1 block per 3-steps of the protocol, and each block requires 3 steps to finalize (block finalization latency).

In some examples, an aggregator or collector of votes may be used to reduce communication complexity in the consensus steps that are broadcast by nodes as described above. However, the sizes of prepare messages are small and that there is not much practical gain all-to-one collectors. For the sake of explanation, the below description is described using the vote-broadcast model, but this is exemplary and an aggregator or a collector configuration can be used.

In a chained example for providing SMR, an algorithm creates overlap and chains the consensus instances. For example, a leader may wait for one QC to be formed for a block before proposing the next one. The QC on a next block serves as the Commit QC for a previous block thus avoiding double voting on a single block and reducing the communication costs per block by half.

In some examples, the nodes including the designated leader may generate various messages during operation of the PBFT. Examples of the messages include Normal Proposal, Fallback Recovery Proposal, Prepare, Timeout, QC and TC. By operating in an Authenticated Byzantine setting, all messages should be signed by the sender and include any information required for a recipient node to verify the signature of the sender. The signature of each sender includes a domain-unique identifier and the round number in addition to the value being signed, to prevent replay attacks on the fully connected network.

In specific examples, a well-formed Normal Proposal contains the proposed block Bᵣ, which, as includes at least the round identifier r, the digest of the parent block B′, and a possibly-empty set of transactions. Including the digest of the parent block B′ in Bᵣ in this manner provides a parent relation B′⇐=Bᵣ. Comparatively, a well-formed Fallback Recovery Proposal contains the proposed block Bᵣ and a well-formed Timeout Certificate for the round r−2, denoted TCᵣ₋₂. The validity conditions for each proposal type are described below A well-formed Prepare vote contains the related block Bᵣ. Since honest processes are allowed to vote up to twice in a given round r, a validator node the node with r_{c}≤r+1 accepts at most two Prepare messages for the current round r from each of its peers to prevent the Byzantine processes from consuming memory by generating excessive votes in any single round. A well-formed QC for a block Bᵣ, denoted QCᵣ, contains Bᵣ and a representation c of a quorum of valid Prepare messages for Bᵣ. A validator the node considers QCᵣ valid only if c proves that QCᵣ was constructed from a quorum of valid Prepare messages for Bᵣ from unique processes. A well-formed Timeout message for a round r, denoted Tᵣ, contains the round index r and a QC for r′<r. This QC should be the highest QC observed by the sender at the time that it created Tᵣ. A validator the node considers Tᵣ valid if it is the first such message from the given sender and the node has not yet garbage-collected r. A well-formed TCᵣ contains the round identifier r and a certificate c constructed from a quorum of valid Timeout messages for r from unique processes. It also contains qc′, the QC with the maximum round number contained in the set of Timeout messages used to construct c. The certificate c must prove both that a quorum of processes have sent Tᵣ messages and that qc′ is the maximum QC submitted by the quorum.

In an example, a valid construction for c is the set containing the pairs (σ(r,qc·r),qc·r), where σ(r,qc·r) is the signature of the sender on both r and the round number of the QC that it included in its Tᵣ. A validator the node considers TCᵣ valid only if c proves the aforementioned properties and qc′ is for a round less than r.

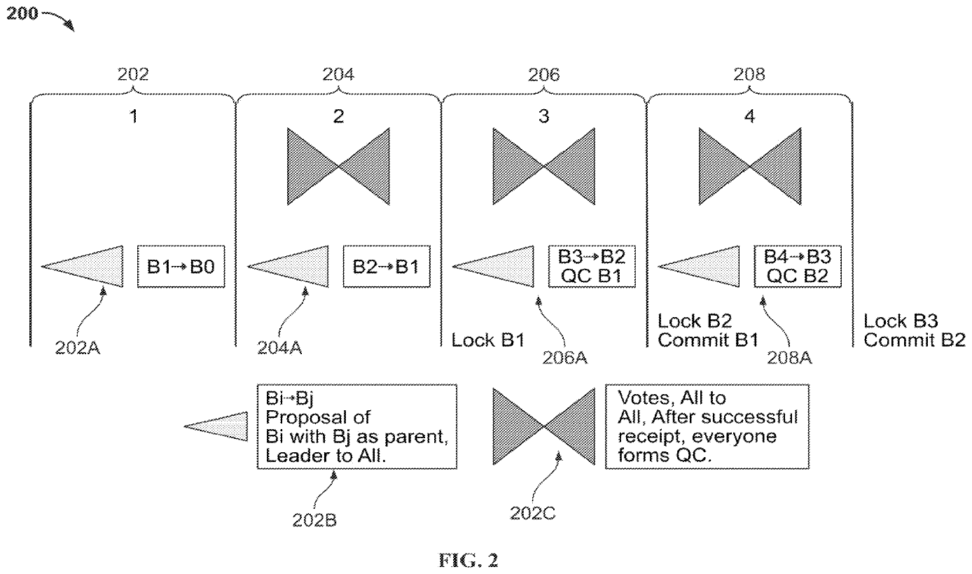

FIG. 2 illustrates an example of a Densely Pipelined PBFT (DP-PBFT) according to one or more embodiments of the present disclosure. As shown FIG. 2, a block is proposed in each round by the designated leader of the round. In the specific example of FIG. 2, a single leader proposes a block in each of the rounds 202, 204, 206, and 208 (collectively “rounds 202-208”).

Upon initialization of a consensus round, each node of the network assigns a local variable r_{cur} that corresponds to a current round to value r (e.g., a number that indicates a serial number of the current round 1, 2, 3 . . . etc.). Each node broadcasts a vote for each proposal of the previous round from Lr−1 by broadcasting a signed Prepare message that represents the vote, such as (Hash(Br−1),rcur). After broadcasting the vote, each node waits to receive valid Prepare messages on Bᵣ₋₁ and a valid Proposal message on Br from the designated leader of the round (Lᵣ). After receiving the prepare messages, the node also forms QC for the previous round Bᵣ₋₁.

For example, a designated leader enters round 202 and constructs and broadcasts a proposal of B₁ that may have the format Proposal (Bᵣ, propQC, propTC) where: Bᵣ (e.g., B₁) is the block being proposed for round 202, and contains at least the fields r (e.g., 202 and/or round 1) holding the round-value and a parent identifier such as “parent” representing the hash of the parent block. In some proposals, additional fields can be included such as “propQC” which may be the QC of the grandparent of Bᵣ or “propTC” which is the Timeout Certificate, which contains the quorum certificate on the timeout messages of the previous round. The fields “propQC” and “maxQC” may be required to include values for blockH, round, and cert similar to a node variable locked and committed. In some configurations, the timeout certificate propTC can include values such as round, the round being timed out on, cert, QC on the Timeout messages (aggregation of 2f+1 messages), listQC, list of 2f+1 signed QCs that were packaged in the 2f+1 timeout messages, and/or maxQC, the QC of the highest round in the listQC.

After performing rounds 202, 204, and 206, the first block 202A is committed. As used herein, “committed” means the transactions in the first block 202A are executed, and a new state of the blockchain is generated. Similarly, the subsequent block proposals (e.g., B₂ and B₂) proposed during rounds 204, and 206 are proposed and validated using the new state of the blockchain. This state behavior is different when using DP-PBFT than other chained SMR protocols. In chained DP-PBFT, a subsequent block is proposed even before the preceding block is committed. In order to perform SMR using DP-PBFT, there are node-state variables holding one or more states of the blockchain on which the new blocks are proposed. As each block is committed, the node-state variables holding one or more states of the blockchain are updated to reflect the committed blocks.

To pipeline multiple instances of the SMR protocol, a refined definition of the validity of a proposal that includes factors more than the direct validity conditions of the block (such as validity of transactions, etc.). For example, the leader may generate a proposal for a block that has the format Proposal (B, propQC, propTC). This proposal is valid for a given freshQC when the Proposal message is signed by Lᵣ AND r_{cur}==r AND if propTC==then voted·blockH==B·parentH AND freshQC·blockH==B·parentH AND propQC==locked, if propTC #⊥ then propQC==1 AND propTC·maxQC·blockH==B·parentH. At the end of each round, the nodes collect the signed prepare messages from other nodes and attempt to form a QC on the block of the current round Bᵣ, and then the next round can begin.

In other examples, a round r may be in progress when any of the expected events do not occur and the node may enter a timeout. For instance, the node may timeout when a crashed leader fails to send the expected Proposal message or a Byzantine leader sends an invalid Proposal message. In this case, the node enters a timeout and sends a Timeout message that includes an index (e.g., a round number) and the QC of the most recent round (e.g., highest index) that has been received by the node. The node attempts to form a TC for the current round identified by r. After forming TC, the node enters the subsequent round rᵣ₊₁, and waits for a new proposal from the leader of the subsequent round. In another instance of a node entering timeout, a required number of Prepare messages is not received by the node because the network is still asynchronous (before GST) and the message latencies are greater than Δ. Here, though node times out and sends Timeout r message indicating that the node may not form a TC for the current round because of network asynchrony. After a time period of the timeout expires, the node resets a timer, waits for the timer to expire, and sends a second Timeout message. The node timeout routine repeats until the network comes to the synchrony phase (e.g., the time is past GST). After the network enters the synchrony phase, a TC is formed, and the node enters the round r+1, and continues with the protocol as described above.

In the example of asynchronous operation causing a timeout, even if the proposal on the previous block Bᵣ₋₁ is valid, the node will ignore the proposal because a QC on Bᵣ₋₁ never gets formed, and the block Bᵣ will not have Bᵣ₋₁ as a parent. The nodes can mitigate this challenge by including votes inside timeout messages. More specifically, if a node has voted (sent a Prepare message) in a round r for Bᵣ₋₁, then its Timeout r message will include the hash of the block it voted for, along with packaging the QC of the highest round the node has received. By including the voting information inside the timeout messages, the TC is formed by aggregating the votes packaged in Timeout r messages, the maxQC is updated to the QC of the highest round including the aggregation of the votes. As such, genuine blocks are not missed, and have proper reference to the respective parent block.

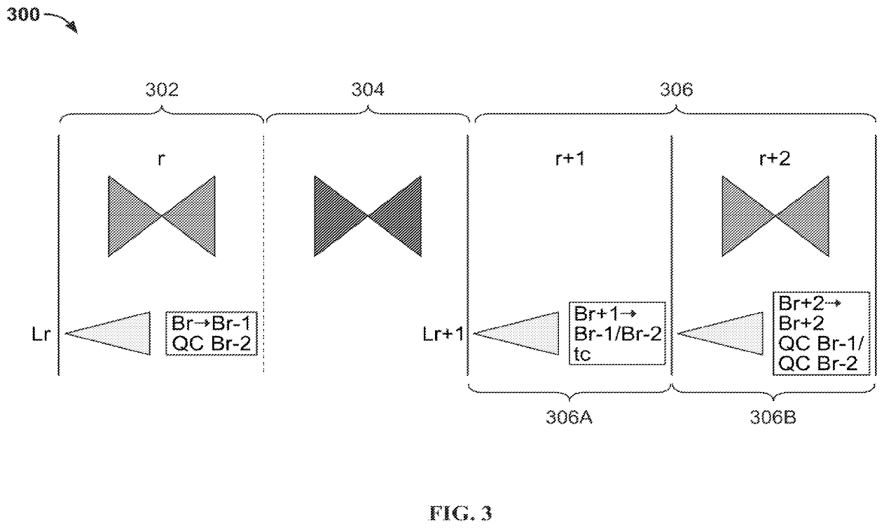

FIG. 3 illustrates a consensus process that includes a node timeout according to embodiments of the present disclosure. For example, the consensus process 300 includes a first round 302, a timeout period 304, and subsequent rounds 306A and 306B, collectively “subsequent rounds 306. As illustrated by FIG. 3, the nodes timeout in the first round 302, form a TC for the first round 302 during a timeout period 304, and after the timeout period 304, proceed to subsequent rounds 306. The designated leader of the subsequent round 306A includes an additional variable in the proposed block for subsequent round 306A that represents the timeout certificate formed during the timeout period 304. Subsequent round 306B shows that the pipelining protocol resumes by depicting the communications including the proposed block from the leader and the QC for the two previous rounds. In some examples, a node lags behind in rounds because of network delays in receiving messages or because of Byzantine leaders who send valid proposals only to some nodes avoiding a targeted some other nodes. To correct the node lag, a node initiates a catch-up process by watching the broadcasted messages that come packed with QCs, Proposal, Timeout, and TC messages. Every node updates a variable such as latestQCMap that represents the QC of the latest round that other nodes in the fully connected network possess. A node that is lagging detects a QC of a round with a higher index than the most recent round the node has received, and initiates the catch-up protocol. Note that the block associated with current round r could still be locked pre-commitment, but the parent block must be committed. The node that is lagging may requests the sender (e.g., a designated leader of all the proposals starting from the most recent block that the node has seen (e.g. the locked QC) to the parent proposal of the proposal received in the current round.

During the catch-up process, a server of the fully connected network looks up a latestQCMap to check if the requesting node (e.g., the node catching up) is not falsely asking for QCs even after possessing corresponding proposals. If the latestQCMap of the sender matches the latestQC map of the requesting node, the server ignores the request to prevent a Denial of Service attack. If the server determines that the request is genuine by detecting a mismatch between the latestQCMap of the server matches the latestQC map of the requesting node, then the server returns a mapping of the round numbers to their corresponding proposals (e.g., mapProp) and a QC of each successor block (evidence of finalization), starting from the proposal of the successor of the locked block (e.g., the last round received by the node) and ending at the parent proposal of the current round. The requesting node updates the local data and the state of the blockchain and moves to the appropriate round.

In some examples, the network has passed its GST while a node in the network is lagging. In this example, the node watches for all the broadcast messages in a round and picks the message with the QC of the highest round and initiates the catch-up protocol with the sender of that broadcast message. In a catch-up protocol with an honest sender, the honest sender serves the requested mapping (e.g., a mapProp as described above). In this case, the catch-up sub-protocol has 2-step latency. In a different case, the requesting node has to request f+1 nodes and then with the latency of 2f+2 steps the node can catch up. For instance, a partition of nodes include a first set of nodes A and a second set of nodes B. In this case, either of the first set of nodes A or the second set of nodes B does not meet the quorum requirement.

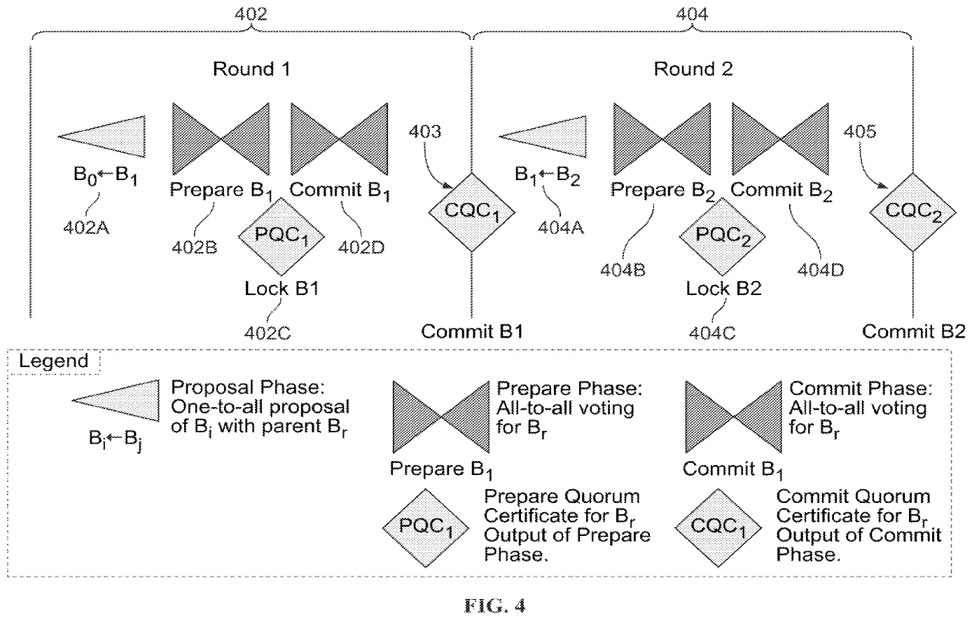

FIG. 4 illustrates a Two-Phase-Commit Blockchain-Based Byzantine Fault Tolerant State Machine Replication Protocol. In the example illustrated by FIG. 4, each round includes a Propose phase, a, Prepare phase, and a Commit phase, respectively. Network communications may be performed by broadcasting all messages over point-to-point links in a fully-connected network. In some instance, the SMR protocol requires if a correct process receives some message at a defined time, all correct processes will receive the message before max{t,GST}+Δ. For the sake of liveness, honest nodes must re-broadcast all messages that they receive.

In a first phase, the leader of the current round broadcasts a proposed block in a signed proposal message 402A. A node (e.g., a validator) that receives the proposal message 402A enters the Prepare phase after receiving a valid proposal message 402A from the leader. The node re-broadcasts the proposal message 402A along with a Prepare message to indicate an endorsement of the proposed block. The node then waits to receive a quorum of valid prepare messages (each of which it must re-broadcast) and then constructs a Prepare Quorum Certificate (Prepare QC) as verifiable proof that a quorum of processes have accepted the leader proposed block. After forming the Prepare QC, the node enters a Commit phase. The node broadcasts a Commit message as a second endorsement of the Proposed block. Similar to as described above, the node then waits to receive a quorum of valid Commit messages before forming Commit Quorum Certificate (Commit CQ) and committing the block. By using this process, a best-case proposal-to-commit latency is a block period of 30 and a communication complexity of O(n3). As used herein, δ to represent the average message transmission latency after GST. δ is measured over the duration of any given run of the related protocol as the average time between the dispatch of any message on a point-to-point link until its receipt, after GST. Accordingly, δ≤Δ. δ is imprecise since it does not factor in either the relative sizes of the different types of messages or the size of the network, but is a suitable approximation.

### Correctness Proofs and Properties of SMR Protocol

An SMR protocol satisfies the following properties:

Consistency. For any two honest nodes the node and v′ either Bv≤B′v or B′v≤Bv.

Liveness. An honest node will eventually add the block to its chain proposed by an honest leader.

External Validity. The external validity condition requires that the decided value satisfies a global predicate that is determined by the particular application and known to all parties. Each party adds some validation data to the proposed value, which serves as the proof for its validity.

The blockchain maintained by an honest node the node is valid, i.e., is WellFormed(Bᵥ).

The External Validity property is easy to see and focus on proving Consistency and Liveness.

Let B←B′ denote B′·parentH=Hash (B). Let←* denote the reflexive and transitive closure of ←.

### Consistency Proof

We introduce some definitions that are required for the proofs and follow the line of proofs:

Definition 1 (Global-direct-commit). A block B is GDC (globally-direct-committed) if at least f+1 honest nodes have locked B.

Lemma 1. If an honest node successfully preforms the commit step on a block B then B is globally-direct-committed.

Proof. Commit step on a block B is performed only after locking a block B′ such that B←B′. A QC on B′ implies that 2f+1 nodes have voted for the proposal on B′.

In the steady path of the protocol, the voting on B′ happens only after locking on its parent, i.e., of B. In the other path, the proposal of B′ accompanies the QC of its parent, i.e., QC of B. Then the nodes vote for B′ only after locking B. Hence at least f+1 nodes have locked B and thus B is GDC.

Lemma 2. Suppose B is GDC. Then it is locked by at least one honest node in Bᵣ₊₂.

Proof. Given that B is GDC. This implies that f+1 honest nodes have locked B in round r such that r>B·round+1. It means that 2f+1 nodes have voted for B in B·round+1, and at least one honest node has formed QC for it at the end of B·round+1, and must have locked it after entering B·round+2. Hence B is certified in B·round+2.

Lemma 3. If a block B is GDC then the value of maxQC.round of any higher-round timeout certificate is at least B·round.

Proof. This is proven by contradiction. Suppose there is a round r>B·round for which the timeout certificate is being formed. Suppose that maxQC.round<B·round. It means that all of 2f+1 nodes contributing the timeout messages for the timeout certificate had seen QCs of blocks of rounds strictly lesser than B·round. By Definition 1, at least f+1 honest nodes have seen the QC for B·round, which is a contradiction.

It follows from the Quorum Intersection argument that:

Lemma 4. Suppose an honest node locks B proposed in round r. Then no other honest node locks a different B′ proposed in round r.

Lemma 5. Suppose B and B′ are GDC with B·round≤B′·round. Then B←*B′.

Proof. Let r′=B′·round and r=B·round.

Suppose r′=r. Then from Lemma 4 B=B′ and hence B←*B′.

Suppose r′>r. Proven by induction on r′.

Base step. Suppose r′=r+1. B is GDC. From Lemma 2, B is locked by at least one honest node in r+2, and B′ is locked by at least one honest node in r′+2, which is the same as r+3. From Lemma 4, no block other than B and B′ for round r and r′ can be locked by any other honest node. It means that B′·parent=B. Thus B←*B′.

Inductive step. Assume that the lemma holds for r′ 1>r, and prove that it also holds for r′.

If no block of round r′ is GDC, then the lemma holds vacuously.

Let B′ be the block of round r′ that got GDC. From Lemma 2, B and B′ must have been locked by at least one node in r+2 and r′+2 respectively. It means that at least f+1 honest nodes must have voted for B in r+1 and B′ in r′+1. By Quorum Intersection argument there is at least one honest node who voted for both B and B′.

Let B″ be the parent of B′, written as B″ B′ and r″=B″.round. There are two cases to consider.

Case 1: r″≥r. From induction hypothesis, B←*B″ and thus B←*B′.

Case 2: r″<r. The rounds r″ and r′ are not consecutive because of r″<r<r′. Hence the proposal of B′ must contain a timeout certificate for round r′−1. By Lemma 3, the value of maxQC.round in the timeout certificate is ≥r. Consider the successful voting scenario of an honest node on B′. From the conditions, it requires that B←B′, which is a contradiction.

Theorem 1. For any two honest nodes the node and v′ either Bᵥ≤Bᵥ′ or Bᵥ′≤Bᵥ.

Proof. Let Bv=B₁←B₂← . . . and Bv′=B′₁←B′₂← . . . . For every round i, both Bᵢ and B′ᵢ are locally committed on the node and v′ respectively. From Lemma 1, for every i, both Bᵢ and B′ᵢ are globally-direct-committed for the same round i. From Lemma 5, then have Bᵢ=B′ᵢ. If |Bᵥ|≤|Bᵥ′| then Bᵥ≤Bᵥ′ otherwise Bᵥ′≤Bᵥ.

### Liveness Proof

Theorem 2. Let r be a round after GST. Suppose all honest nodes are in round r. Then a honest node commits a block B with B·round≥r.

Proof. Because r is a round after GST, the message latencies amongst honest nodes are bounded by a known A. Note that our round-timers are set to expire after a time greater than Δ. Hence the messages of honest nodes will be received before the timeout in all rounds≥r.

Because Byzantine nodes are fewer than f, there exists round r₁, r₂ and r₃ s.t. r≤r₁<r₂<r₃ and Lᵣ₁, Lᵣ₂ and Lᵣ₃ are honest, and for all r_{b} with r<r_{b}<r₁, r₁<r_{b}<r₂, and r₂<r_{b}<r₃, Lr_{b} is Byzantine. Now the Byzantine leaders could have invalid proposals in all those rounds r_{b} forcing all the honest nodes to timeout and form a timeout certificate and graduate to the next round. Note that even though the round times out because of an invalid proposal, all the votes for the latest valid proposal prior to r_{b} are still aggregated to a QC. Through the formed timeout certificate, this QC will be utilized in the next round to update the variables locked and committed.

To start with, all honest nodes are in round r. Every honest node keeps timing out because of invalid proposals in all rounds r_{b}, r≤r_{b}<r′, and reaches the round r₁. Because Lᵣ1 is honest, it broadcasts a valid proposal Bᵣ₁. All the honest nodes receive this proposal within Δ time in round r₁, and they enter round r₁+1 and vote on Bᵣ₁. At the end of round r₁+1, all honest nodes form a QC on Bᵣ₁. Because of the Byzantine leaders in the rounds r_{b}, r₁<r_{b}<r₂, the honest nodes keep timing out successively in rounds r_{b}, and reach the round r₂. However, through the timeout certificate, the QC on Bᵣ₁ is passed and the variable locked is set to Bᵣ₁.

Similar to step 3 (above), the honest leader Lᵣ₂ proposes a valid proposal Bᵣ₂ with Br₂ₚₐᵣₑₙₜ=Bᵣ₁ and at the end of round r₂+1 all nodes form QC on Bᵣ₂. Similar to step 4 (above), when the next honest leader's round is reached, which is r₃, then Bᵣ₂ gets locked and Bᵣ₁ gets committed.

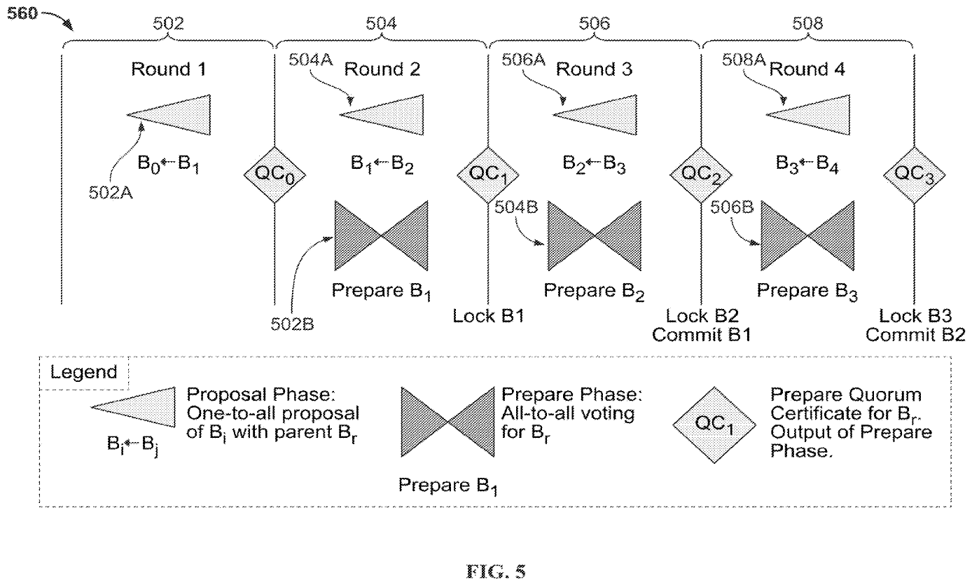

FIG. 5 illustrates byzantine fault tolerant blockchain-based state machine replication according to embodiments of the present disclosure. The blockchain-based SMR as depicted by FIG. 5 includes a first round 502, a second round 504, a third round 506, and a fourth round 508. The designated leader communicates a first proposed block 502A, a second proposed block 504A, a third proposed block 506A, and a fourth proposed block 508A to the nodes of the fully connected network. In the second round 504, the nodes generate a Prepare message 502B for the first proposed block 502A communicated in the first round 502. At the completion of the second round 504, the first proposed block 502A is locked. In the third round 506, the nodes generate a Prepare message 504B for the second proposed block 504A communicated in the second round 504. At the completion of the third round 506, the second proposed block 504A is locked and the first proposed block 502A is committed. In the fourth round 508, the nodes generate a Prepare message 506B for the third proposed block 506A communicated in the third round 506. At the completion of the fourth round 508, the third proposed block 506A is locked and the second proposed block 504A is committed. While four discrete rounds are shown, this process can continue for any length.

Being a blockchain-based SMR protocol, Chained Moonshot proceeds in rounds. Each v∈ [symbol] is assigned the role of either leader or validator upon entering a new round. The leader of each round, Lᵣ, is elected via a function L that is assumed to be fair, giving every process in the system equal opportunity to become leader. A distinguishment is made between deterministic fairness and probabilistic fairness. A deterministically fair L guarantees that there exists some k such that each v∈ [symbol] leads exactly k rounds every kn rounds. Comparatively, a probabilistically fair L guarantees that there exists some k such that the expected number of rounds lead by each v∈ [symbol] every kn rounds is k. No assumptions are made about whether L can be used to predict leaders in advance and/or that there are known strategies for preventing this when it is considered undesirable. Lᵣ has access to a pool of unique, uncommitted transactions or abstractions thereof that it samples from when creating a new block, but leave the related selection function abstract.

Since the definition of Liveness given in Definition 3 requires at least one honest block proposal to be committed during each synchronous interval lasting at least M, the leader election function of [symbol] must deterministically elect at least one honest leader during this time (notice that this is a necessary condition for Liveness, but is not sufficient). Consequently, any [symbol] that uses a probabilistic L can only be said to obtain probabilistic liveness under this definition.

As illustrated in FIG. 5, the blockchain-based SMR has a best-case (e.g., no timeouts) block period of A. A liveness of the blockchain-based SMR is a guarantee that a protocol can exchange messages between the network nodes, allowing them to come to a consensus. The liveness of blockchain-based SMR protocols depends on a leader being able to refer to the block proposed for the previous height when making its own proposed block, meaning that the Propose phases of each round must proceed sequentially. However, the safety of such protocols is dictated by the rules for voting on blocks and committing blocks locally for each node. For example, a Propose phase for a given height (i.e., a specific location in a blockchain measured by how many confirmed blocks precede the height) is actually independent of their corresponding Prepare phases with respect to safety despite being dependent on the Propose phases of the previous heights for liveness. By using the height, the Prepare phase of an earlier round can be safely overlapped with the Propose phases of subsequent rounds. The overlap permits designated leaders of subsequent rounds to extend beyond blocks not yet accepted by a quorum. As a result, the bandwidth utilization is improved because Prepare votes and new Proposed blocks are transmitted concurrently.

During operation of the fully connected network, the combination of the designated leader and the set of nodes form a blockchain including multiple blocks that are linked together. For each block, the designated leader communicates that a leader is designated for each round and is expected to change in the next round. During each round, the designated leader proposes a well-formed chained block Bᵣ that includes the round identifier r that represents the round in which the block was proposed. The well-formed chained block Bᵣ also includes a digest of its parent block B′, and a payload. The payload represents a totally-ordered set of transactions from the clients of the system. For example, the payload may be empty because forming consensus on the transaction order does not require a payload to include the data relating to a client transaction.

The DP-PBFT communication complexity can be computed using the total number of nodes of the network n, and the maximum number of Byzantine nodes tolerable by the protocol f, and n≥3f+1. Each of the QCs are of size O(1), which can typically be achieved using threshold cryptography. As described above, the timeout certificates contain 2f+1 signed QCs. Thus, the size of timeout certificates is treated as O(n). The proposal messages that are broadcast by the leader to all the nodes in the network may include a timeout certificate. As such, the proposal messages are also of the size O(n). Hence the proposal step is a O(n²) step network-wide. Because the prepare messages are broadcast by every node to all the nodes in the network, the prepare step is a O(n²) step. The timeout messages are of size O(1) because they include one QC (of highest round that the node has seen). When a timeout occurs, every node broadcasts a timeout message to every other node. Because the timeout messages are broadcast to every other node, the timeout step is also O(n²). So, in summary, the communication complexity of DP-PBFT overall is O(n²).

In some examples, the communication over-head of the preceding protocol can be reduced by including block digests in Prepare and/or QC messages rather than the entire blocks. In some examples, the preceding protocol of including block digests is called a “Moonshot” protocol as it reduces latency of the blockchain. The nodes in the fully connected network can be configured to include Prepare and QC messages that contain both the digest and round number of the related block instead of containing blocks. Additionally, by including the QCs and the digest of the parent of the related block then the semantics of the tryCommit function can remain unchanged. Otherwise, QCs may omit this field if tryCommit is provided with access to certified blocks and is also invoked as each new certified block arrives. Most significantly though, these example configurations require the addition of a synchronization subprotocol to ensure that the protocol maintains the Liveness SMR property.

As described above, some nodes may fall behind their peers due to either normal network asynchrony or an adversary deliberately delaying messages. While some networks may have perfect communication channels with all blocks that are sent by honest leaders will eventually be delivered to all honest validators. However, perfect channels are insufficient to ensure that every validator eventually receives every finalized block when Prepare messages and QCs do not contain the related block.

The reason that every validator may not eventually receives every finalized block is because it is still possible for Byzantine leaders to censor a subset of the honest validators when broadcasting Proposed blocks. To mitigate this, a Block Synchronization Protocol can ensures that if one honest process commits a block then all other processes will eventually do the same. A node initiates the Block Synchronization Protocol when the node becomes aware of the existence of a committed block that it has yet to receive. The node detects this mismatch when the node receives a QC for a block that the node does not have. To remedy the mismatch, the node multicasts a Sync Request message containing the digest of the missing block to various peer nodes. Any honest peer that receives such a Sync Request first ensures that the sender has not exceeded the agreed upon rate-limit for Sync Requests before checking its storage for the requested block. If the honest peer has the block stored locally, the honest peer then unicasts a Sync Response containing the missing block to the node that sent the Sync Request. The existence of the QC for the missing block indicates that at least f+1 honest nodes received the missing block, so since n=3f+1, the node is guaranteed to eventually receive the missing block from at least one honest peer. After receiving the missing, the node authenticates the Sync Response by confirming that it had previously requested missing block and then processes the received missing block.

If a node discovers that it is missing the parent of a missing block while processing the missing block that was received as described just above, then the node sends an additional Sync Request. These steps of identifying a missing block, sending a Sync Request, receiving the missing block, and processing the missing block are repeated until the node has processed all missing blocks between its last committed block and the first identified missing block.

Additionally, the number of nodes that receive the multicast of the Sync Request message can be reduced when the sender has the related QC in its possession, if the QC identifies it contributors. This is because the of a Voting Rule that ensures that each honest contributor is guaranteed to possess the related block. The Block Synchronization Protocol has a best-case latency of 2δ after GST and communication complexity of η(f+1) messages per block, assuming a QC implementation that preserves the identities of the voters. It is possible to achieve a communication complexity of Ω(1), O(f+1) per block in the same setting by having the sending node contact peer nodes one at a time.

By contacting peer nodes one at a time, the latency remains 2δ in the best case but increases to f+1Δ in the worst case. The communication complexity of the full synchronization process can be further optimized by having the node request multiple blocks from the single peer node once it has identified an honest peer node. In this variant, the node that receives the missing block from the honest peer follows the previously described protocol for processing the first missing block. After receiving the first missing block from the honest peer, the node then directs all future Sync Requests to the honest node until the node fails to receive a response within a predetermined timeout interval. In the event the node fails to receive the response within the predetermined timeout interval, the node repeats the original Block Synchronization protocol until it receives the requested block and so on until it has synchronized all of its missing blocks.

Another important aspect of the present disclosure is that the blockchain is an externally verifiable blockchain. An externally verifiable blockchain enables nodes outside of the fully connected network that have the membership of the network and the public keys of its constituents to verify that a given block is a part of the canonical blockchain by way of a Commit Certificate. In a first example of forming a Commit Certificate, Moonshot persists all finalized blocks and each finalized blocks corresponding QC. A validator node can construct a Commit Certificate for a block Br without any modifications to the protocol by aggregating the blocks forming the subsequence of the blockchain from Bᵣ to Bₛ, Bₛ₊₁ such that Bₛ and Bₛ₊₁ are proposed in rounds s and s+1 respectively, s≥r, and; Bₛ is the parent of Bₛ₊₁. The QC for Bₛ₊₁. This construction proves that By is an ancestor of a block that satisfied the Chained Moonshot Commit Rule, namely Bs.

Alternatively, the system could generate Commit Certificates by performing an additional round of f+1-threshold agreement for each finalised block. For example, a validator could broadcast its signature on each block that it commits (along with any other data that the implementer wishes to use to distinguish this message from a Prepare message) and aggregate f+1 such signatures to form a Commit Certificate. Under this construction, the Commit Certificate guarantees that at least one honest process has committed the related block, so the Safety and Liveness properties of the system ensure that every other honest process will eventually do the same.

In a normal path, all nodes start in round 1 upon the initialization of the Chained Moonshot protocol. If L₁ is honest then it attempts to create and broadcast B₁, a child of B₀, as a Normal Proposal. Subsequently, all honest processes immediately advance to round 2 via QC₀ and reset their round timers.

More generally, an honest node v enters round r+2 via the Normal Round Transition Rule and resets its round timer after observing a QC for r. After entering round r, Lᵣ becomes eligible to propose a Normal Proposal and v becomes eligible to vote for proposals from Lᵣ₋₁. Specifically, the first time that Lᵣ possesses a Normal Proposal N=B′⇐Bᵣ₋₁ from Lᵣ₋₁ whilst in r it tries to create a Normal Proposal of its own. If Lᵣ has not already created a proposal for r, then it will succeed and will create and broadcast a Normal Proposal containing Bᵣ₋₁⇐Bᵣ.

Lᵣ does not verify the certification of either Bᵣ₋₁ or its parent before making its own proposal. Instead, it proposes optimistically, assuming that both blocks will become valid if they are not already, and that their certificates will be locked by a quorum of its peers. If Lᵣ₋₁ is Byzantine it can therefore take advantage of this fact to cause Lᵣ to create an invalid Normal Proposal by sending it an arbitrary block for r−1. However, Lᵣ will usually eventually be able recognise that it has been lied to and will update its proposal accordingly.

Comparatively, v is not permitted to vote for Bᵣ₋₁ unless it is locked on a QC for B′. This helps the protocol to obtain the Safety SMR property, as elucidated in Section 8. In addition to being locked on the QC for B′, v must not yet have voted for a Normal Proposal from Lᵣ₋₁, must not have sent Tᵣ and B′ must have been proposed for r−2. If all of these conditions are satisfied then v considers Bᵣ₋₁ to have satisfied the Normal Vote Rule and broadcasts a Prepare vote for Bᵣ₋₁.

After observing a quorum of Prepare votes for Bᵣ₋₁ from unique processes including itself, v constructs a QC for Bᵣ₋₁ by aggregating the Prepare votes into a verifiable proof that a quorum of processes voted for Bᵣ₋₁.

The first time that v observes a valid QCᵣ, which happens when v either constructs QCᵣ itself or receives it from one of its peers in a protocol message, v executes the QC Processing Rule. Importantly, if v receives QCᵣ in another protocol message then it processes QCᵣ before the message that contains it. Firstly, v checks the round of the QC. If v is currently in round r+1 then it attempts to propose via the QC Extension Rule. This attempt only succeeds if v is Lᵣ₊₁, has not yet created a Fallback Recovery Proposal for r+1 and has not yet created a Normal Proposal extending the certified block. Importantly, this rule allows Lᵣ₊₁ to re-propose if it originally created an invalid Normal Proposal due to receiving an equivocal or invalid Normal Proposal from Lᵣ.

Subsequently, v adds QCᵣ to its set of uncommitted QCs before attempting to lock it. The Lock Rule only allows v to lock QCᵣ if r is greater than the round of its currently locked QCᵣ it is in r+1 or lower and has yet to send Tᵣ. Intuitively, since v is only allowed to vote for a Normal Proposal if it is locked on its parent, the final requirement ensures that if f+1 honest processes send Timeout messages for r then it will be impossible for any honest process to observe a QC for a Normal Proposal for r+1. This helps to ensure the Safety of the protocol, the complete proof for which is given in Section 8.

After trying to lock QCᵣ v checks whether it authorises the commit of any new blocks. It does this by checking whether its set of uncommitted QCs contains a block B′ such that either B′⇐Bᵣ and B′·r=r−1 or Bᵣ⇐B′ and B′·r=r+1. In the former case, QCᵣ triggers the Commit Rule for B′ and in the latter the QC for B′ does so for Bᵣ. This check prevents the adversary from delaying commits by delivering QCs out of order. In both cases, v schedules the committed block to be appended to Bᵥ once it has received all of its ancestors.

Next, v broadcasts QCᵣ to ensure that all of its peers will observe it in a timely manner. This is necessary to ensure the Liveness of the protocol, which the adversary can otherwise inhibit, as discussed in Section 5. Finally, v attempts to enter r+2 as previously described.

In addition to the aforementioned actions that v takes upon entering round r it also becomes free to purge all Prepare and Proposal messages for r′≤r−2, but must continue to accept previously unseen QCs for lower rounds.

In a Fallback path, an honest process v enters a new round r at time t. It subsequently enters the fallback path if it fails to observe a QC for any block proposed in r−1 before t+τ, where τ>8Δ. If v fails to observe TCᵣ₋₂ before this time then it broadcasts Tᵣ₋₁. Alternatively, if it does observe this TC then it triggers the Timeout Extension Rule instead, increasing its timeout threshold to t+τ+Δ to ensure that it will always be able to lock the QC for any Fallback Recovery Proposal made by Lᵣ₋₁ while the network is synchronous, as proven in Lemma 12. If v broadcasts Tᵣ₋₁ as a result of its round timer expiring or as a result of any of the following rules, then it adds r−1 to its set of expired rounds, ignores any subsequently received proposals from Lᵣ₋₁ and accepts but does not lock any related QC.

As mentioned in the message definitions, an honest process that has r_{c}≤r+1 accepts the first Timeout message for r containing a QC for a round r′<r that it receives from a given sender. This latter check simplifies the proof for Lemma 3 and also enables v to identify Byzantine Timeout messages, since no honest process will ever send a Tᵣ that includes QCᵣ or higher due to the Normal Round Transition Rule.

If v observes f+1 valid Tᵣ messages from unique senders including itself before observing QCᵣ then it triggers the Timeout Sync Rule and broadcasts its own Tᵣ if it has not already done so. If v waits at least 5Δ after entering r+2 before garbage collecting Timeout messages for r or lower, which is facilitated by the aforementioned cleanup function, then this rule provides two important guarantees. Firstly, it guarantees that all honest process are eventually able to enter to r+2 or higher regardless of the behaviour of the adversary. Additionally, it ensures that honest leaders after GST will always be able to make valid Fallback Recovery Proposals if the corresponding TC exists. This bound is proven in Lemma 8.

After observing a quorum of valid Tᵣ messages, v constructs TCᵣ as previously described. The first time v observes such a TC, be it as a result of constructing the TC itself or due to receiving it in a protocol message, it executes the TC Processing Rule. As with QCs, v executes this rule for any TCs that it receives in Fallback Recovery Proposals before processing the related proposals.

Initially, v broadcasts T, and enters r+2 if it has not done so already. It then attempts to create a Fallback Recovery Proposal containing a new block B′⇐Bᵣ₊₁, where B′ is the block certified by TCᵣ·qc′, which it will only succeed in doing if it is Lᵣ₊₁, it is currently in round r+2 and it has not already created such a proposal. Like the QC Extension Rule, this rule allows Lᵣ₊₁ to correct any Normal Proposal that it may have made as a result of previously observing a Normal Proposal from Lᵣ, which it can infer is now guaranteed to fail. As previously observed, v's observation of TCᵣ makes this inference possible because of the Lock and Normal Vote Rules. Finally, as previously mentioned, if v is currently in r+2 then it triggers the Timeout Extension Rule and increases its round timer by Δ.

Any validator in r that possesses a Fallback Recovery Proposal F (Bᵣ₋₁, TCᵣ₋₂) from Lᵣ₋₁ ensures that the parent of Bᵣ₋₁ is the block certified by TCᵣ₋₂·qc′. The first time that these conditions are satisfied v attempts to create a new Normal Proposal extending Bᵣ₋₁, succeeding only if it is Lᵣ. It then attempts to send a Prepare vote for Bᵣ₋₁, succeeding only if it has not yet voted for a Fallback Recovery Proposal for r−1 and has not yet sent Tᵣ₋₁.

As described above, embodiments of the present disclosure require nodes to rebroadcast all QCs that they observe in order to preserve Liveness of the fully connected network. Without this rule, the current protocol would otherwise be vulnerable to the following attack from the adversary. For example, all honest peers may be executing round r, whilst preventing the certification of the parent of the proposed block and by extension, of the proposed block. Additionally, Moonshot neutralizes the attack vector by allowing a leader to replace its optimistic Normal Proposal with a fully-justified Fallback Recovery Proposal. This is facilitated by the Moonshot Lock and Normal Vote rules. The Moonshot lock rules ensure that if an honest process sends Tr then the system does not lock the block Br. The Normal vote rules ensure that if an honest process is not locked on Br then the node will not vote for N=Br⇐=Bᵣ₊₁. Consequently, if Lᵣ₊₁ observes TCᵣ after optimistically proposing N, then it can infer that at least f+1 honest processes must not having entered r via QCᵣ₋₂. Suppose also the Lᵣ₋₁ have observed QCᵣ in time to lock it and therefore will not vote for N. This allows Lᵣ₊₁ to use TCᵣ to justify N was Byzantine and multicast a valid Normal Proposal to only f+1 honest peers. These f+1 honest peers therefore will vote for the related Bᵣ₋₁, giving the adversary control over QCᵣ₋₁. The adversary can then selectively deliver this QC to a set A of one or more honest peers, causing them to enter r+1 while the remainder, say B, remain behind in r. Subsequently, if the adversary continues to withhold QCᵣ₋₁ from them then the processes in B will eventually send Tᵣ₋₁. However, if this occurs more than 5Δ before GST then the processes in A will garbage collect r−1 and will no longer send Tᵣ₋₁ even if they eventually observe f+1 of Tᵣ₋₁ from their peers in B. Consequently, if the Byzantine processes remain silent, or if A contains more than f honest peers, then B will remain permanently stuck in r.

Some problems still arise even if garbage collection of Timeout messages is removed, since this does not remove the power of the adversary to control QCs either before GST or when the proposer is Byzantine. If the adversary has this power then, per the previous example, it can always cause an honest process to enter a new round via this QC, which, by the Timeout Sync Rule, will prevent it from ever sending the corresponding Timeout message.

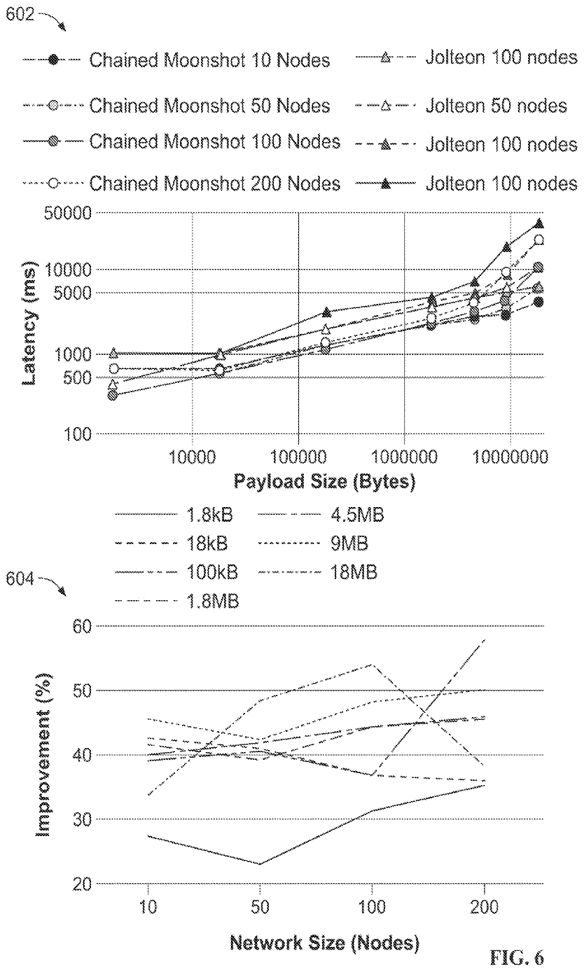

FIG. 6 illustrates a performance comparison between embodiments of the present disclosure and some other blockchain-based SMR implementations. As illustrated by FIG. 6, Jolteon is an efficient implementation and has multiple publicly-available configurations with different numbers of nodes. The two consensus protocols (e.g., embodiments of the present disclosure “Moonshot” and “Jolteon”) in isolation with various configurations of nodes. During the test, the block proposers of each protocol created parametrically sized payloads during the block creation process. The TCP-based network stack way a typical implementation to ensure that any differences in performance were solely due to the differences between the consensus protocols themselves.

As illustrated by the chart 600 of FIG. 6, a throughput and latency are compared across two dimensions. The first dimension is the size of the network and the second dimension is the size of the block payload. Throughput may be measured using two metrics. A first metric of throughput may be the number of blocks committed by at least one process in the network during a run, hereafter referred to as block throughput. A second metric of throughput may be the average number of bytes of payload data transferred per second during the run, hereafter referred to as transfer rate. In the example illustrated by FIG. 6, the second metric is used to produce the comparison. For latency, the time is measured between the creation of a block and the commitment of the block.

Chart 604 of FIG. 6 illustrates networks of various node sizes. More specifically, the networks included in the comparison have sizes of 10, 50, 100 and 200 nodes. The networks were tested using seven payload sizes ranging between 1.8 kB and 18 MB, where individual payload items were 180 bytes in size. The payload size was incremented by an order of magnitude after each test in order to quickly identify the approximate transfer rate limit of each protocol in the larger networks. To produce the chart 602 and the chart 604, the testing networks were constructed from m5·xlarge AWS EC2 instances running Ubuntu 20.04. Each of these instances had a network bandwidth of up to 10 Gbps3, 16 GB of memory and Intel Xeon Platinum 8000 series processors with 4 virtual cores. The instances were distributed across various regions. All nodes were configured to be honest to simulate typical operating conditions. During the testing, the timeout interval τ was set to five seconds for both protocols.

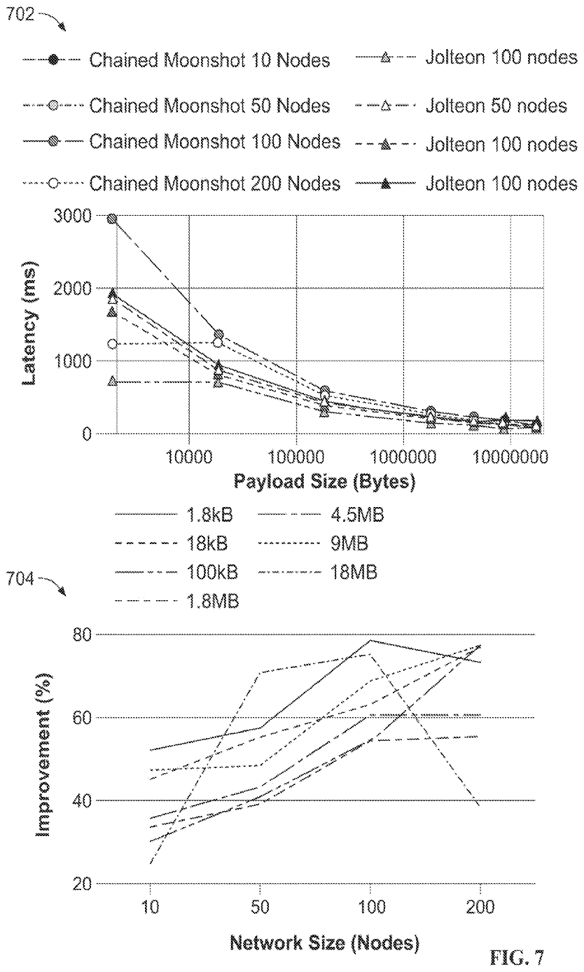

FIG. 7 illustrates another performance comparison between embodiments of the present disclosure and some other blockchain-based SMR implementations. As shown by FIG. 7, Moonshot outperformed Jolteon in both latency and throughput in every configuration, averaging 41.1% lower latency and 54.9% higher throughput across all configurations. Most configurations exhibited relatively consistent latency improvements, but Moonshot consistently produced its smallest improvements for the 1.8 kB payload size, which should have had similar dissemination times for both Proposals and Prepares and thus, according to our simple analysis, should have produced the greatest improvement. Comparatively, increasing the payload size did little to reduce Chained Moonshot outperformance, with every other payload size averaging at least 39% lower latency than Jolteon across all network sizes, with many configurations exceeding the maximum expected improvement of 40%, implying that its vote-broadcasting incurs negligible overhead under these configurations. The minimum of 22.8% decreased latency relative to Jolteon was produced by the 50 node, 1.8 kB configuration, while the maximum decrease of 58.7% was seen in the 200 node, 180 KB configuration. Moonshot's relative improvement in throughput compared to Jolteon generally increased with the size of the network, increasing from 38.2% better on average for the 10 node network to 65.7% better on average in the 200 node network. However, its increase in throughput was generally much less than expected for the smaller payload sizes and fluctuated as the payload size increased rather than decreasing as expected. Moonshot produced a maximum throughput increase of 78.4% for the 100 node, 1.8 KB configuration, with the minimum of 24.5% coming from the 10 node, 18 MB.

In some examples, the local blockchain of each node represents a totally-ordered sequence of blocks Bᵥ=(B₀, Bᵣ, . . . , Bₕ), indexed by the rounds for which they were proposed. Upon initialization, every node is initialized with block B₀, a common Genesis Block that contains all configuration information required by the system at start-up. Each node is assigned the role of either leader or validator upon entering a new round. The designated leader of each round, Lᵣ, is elected via a function L that may be assumed to be fair, giving every node in the fully connected network an equal opportunity to become leader. As expected, both protocols showed both an increasing transfer rate and increasing commit latency as the payload size increased, but eventually reached a point of saturation after which increasing the payload size decreased the transfer rate but continued to increase the latency. Both protocols reached saturation in the 100 and 200 nodes networks, with both recording their maximum transfer rates with the 9 MB payload in the 100 node network and the 4.5 MB payload in the 200 node network. Jolteon maximized its transfer rate at 2.7 MB/s in the 100 node network, compared to the 4.6 MB/s of Moonshot. Comparatively, Moonshot produced 2.6 MB/s in the 200 node network, while Jolteon achieved only 1.6 MB/s. Neither protocol reached saturation in the 50 and 10 node networks under the tested payload sizes. To clarify the trend in the 10 node network configuration, a 180 MB payload test was added. As FIGS. 6-7 show, Moonshot consistently outperformed Jolteon in all configurations.

Further to performance, Moonshot's rules for voting, locking, and committing enable processes to participate in consensus without possessing the full blockchain, making it particularly useful for systems that decouple transaction ordering, delivery and execution. This also improves the performance as it allows the block synchronization protocol and consensus to run in parallel.

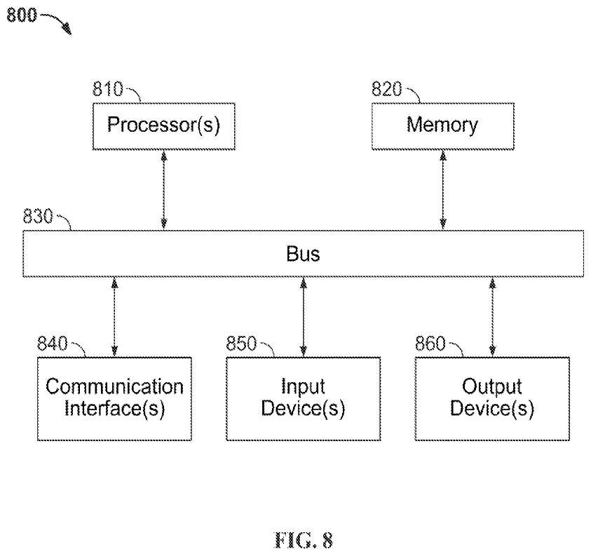

FIG. 8 illustrates an example of a computing device 800 of a computer system capable of implementing the densely pipelined PBFT (“DP-PBFT”) BFT SMR Protocol. The computing device 800 may include processor(s) 810 (e.g., CPU, GPU, or other processing unit), a memory 820, and communication interface(s) 840 (e.g., a network interface) to communicate with other devices and receive data from those devices, such as proposed blocks, votes, certificates, and other information, as described above. Memory 820 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 820. The computing device 800 may, in some embodiments, further include input device(s) 850 (e.g., a keyboard, mouse, joystick, controller, or touchscreen) and output device(s) 860 (e.g., a display, head-up display, AR display, VR display, printer). The aforementioned elements of the computing device 800 may be connected to one another through a bus 830, which represents one or more busses. In some embodiments, the processor(s) 810 of the computing device 800 includes both a CPU and a GPU. In some embodiments, the computing device 800 may be a networked set of computing devices communicatively coupled to a communication network such as a wireless network, wired network, cellular, satellite, or other means of communication between the networked computing devices.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, configure and/or cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

A fully-connected network may be composed of a set V={v₁, . . . , vₙ} of n processes running a protocol P in the Authenticated Byzantine setting. Accordingly, it is assumed that the existence of an adversary works to violate the guarantees of P. The adversary is allowed to corrupt up to f processes when the network is initialized, which thereafter is referred to as being Byzantine and to the remainder as being honest. The adversary is assumed to control all communication channels, with the following caveats: the communication channels between the processes in V are perfect, meaning that messages sent by honest processes cannot be lost in transit and cannot be dropped by the adversary, and that these channels are collectively partially synchronous.

Definition 1. For every run R of P, there is a time T such that Δ holds as an upper bound on time taken for message delivery between each pair of honest peers (vᵢ, vⱼ)∈the node×the node in [T, ∞). Such a time T is called the Global Stabilisation Time (GST).

A modified version of this definition allows for alternating periods of asynchrony and synchrony during a given run R of P. Our updated definition aligns with the observation in that Δ need not hold as the upper bound on message delivery forever after GST, but instead that it need only hold until GST+M where M is the minimum duration of synchrony required for P to be guaranteed to make progress. The modified version of partial synchrony follows.

Each (possibly infinite) run of P, denoted R=((A₀, S₀), (A₁, S₁), . . . ), as a sequence of pairs of finite time intervals with durations determined by the adversary prior to the start of the run. The adversary is allowed to cause (any and) all communication channels to become asynchronous at their discretion during each Aₖ (k≥0), allowing them to arbitrarily delay messages of their choice. The initial moment of each Sₖ is the next Global Stabilisation Time, at which time the adversary must deliver all in-transit messages and after which they must ensure that all protocol messages have an upper bound of Δ on their delivery latencies for the duration of the subsequent synchronous interval Sₖ. For the sake of simplicity, assume that 4 is known to the designer of [symbol] . Use S_{R} to denote the set of all synchronous intervals in R.

Thus the formal definition of Partial Synchrony With Repeated GST is as follows:

Definition 2. For every run R=((A₀, S₀), (A₁, S₁), . . . ) of P, Δ holds as an upper bound on time taken for message delivery between each pair of honest peers (vᵢ, vⱼ)∈the node×the node for the duration of each S∈SR. The first moment of each S∈SR is referred to as a Global Stabilisation Time.

Definition 3. In a partially synchronous network of n processes with an f-limited adversary, P satisfies the following properties:

Proposal: Fallback. Upon first observing TCᵣ₋₁, the node creates a Fallback Recovery Proposal B′⇐=Bᵣ, where B′ is the block certified by the QC with the highest round number included in TCᵣ₋₁, only if it is Lᵣ and is in r+1.

Proposal: Fallback Extension. If the node receives a Fallback Recovery Proposal F containing the block B″⇐=Bᵣ₋₁ from Lᵣ₋₁ whilst in round r, then it creates a Normal Proposal containing Bᵣ₋₁⇐=Br only if F is justified by TCᵣ₋₁, B″ is the block certified by the QC with the maximum round number included in F, the node is Lᵣ and F is the first Fallback Recovery Proposal for r−1 that satisfies these conditions.

Round Transition: Fallback, the node enters r+1 from r′<r+1 after observing a TC for r−1.

Timeout, the node resets its round timer upon entering round r and broadcasts Tᵣ₋₁ if it remains in r for the duration of its timeout delay without otherwise broadcasting this message.

Timeout Extension. Upon observing TCᵣ whilst in r+1 before broadcasting TCᵣ, the node updates its timeout delay from the default of to T+Δ.

Timeout Sync. If the node observes f+1 Timeout messages for r and has not observed QCr then it broadcasts Tᵣ if it has not already done so. Likewise, upon observing TCᵣ and having not yet sent Tᵣ, the node broadcasts Tᵣ.

Vote: Fallback. Whilst in r+1 the node sends a Prepare vote for a block B′⇐=Br received in a Fallback Recovery Proposal F from Lᵣ, only if it has neither sent Tᵣ nor already voted for a Fallback Recovery Proposal for r, F is justified by TCᵣ and B′ is the block certified by the QC with the maximum round number included in TCᵣ.

Definition 4 (Local Direct-Commit). B is locally direct-committed (LDC) by a process the node when the node executes the Chained Moonshot Two-Chain Commit Rule on B.

Definition 5 (Local Commit). B is locally committed (LC) by the node when the node locally direct-commits (LDC) B′ such that B⇐=*B′.

Definition 6 (Global Lock). A block B proposed in r is Globally Locked (GL) if there are at least f+1 honest peers that lock the QC for B whilst in r+1 and before sending Tr.

### Safety Proof

For the safety proof, the term Normal QCr is used in the informal name of Lemma 1 to refer to a QC for a Normal Proposal for round r.

Lemma 1 (TCᵣ₋₁ implies no Normal QCᵣ). If TCᵣ₋₁ exists, then no Normal Proposal for r will ever become certified.

The existence of TCᵣ₋₁ implies that at least f+1 honest peers sent Tᵣ₋₁ before observing QCᵣ₋₁. Therefore, since the Lock Rule requires a process to not have sent Tᵣ₋₁ in order for it to lock QCᵣ₋₁ and since a process can only lock a QC after observing it, at most f honest peers will ever lock QCᵣ₋₁. Consequently, since the Normal Vote Rule requires a process that receives a Normal Proposal N containing the block Bᵣ₋₁⇐Bᵣ to have locked the QC for Bᵣ₋₁ in order to vote for Bᵣ, at most f honest peers will ever send a Prepare vote for Bᵣ. Therefore, since there are only f Byzantine processes and because QCs can only be constructed from 2f+1 Prepare votes from unique processes, Bᵣ will never become certified.

Lemma 2 (Round Safety). Suppose two processes vi and vj observe QCs for blocks Bᵢ and Bⱼ, respectively. If Bᵢ_{ᵣ}=Bⱼ_{ᵣ} then Bᵢ=Bⱼ.

Suppose Bᵢ_{ᵣ}=Bⱼ_{ᵣ} and Bᵢ├Bⱼ. By the Vote Rule and the definition of a QC given above, the existence of the QCs for Bᵢ and Bⱼ implies that at least f+1 honest peers voted for each of them in Bᵢ_{ᵣ₊₁}. Furthermore, since there are only 2f+1 honest peers, at least one of these honest peers must have voted for both Bᵢ and Bⱼ. However, if Bᵢ and Bⱼ were both proposed as Normal Proposals or both as Fallback Recovery Proposals then because the rules for voting only allow an honest process to vote for one proposal of each type per round, no honest process could have voted for both blocks. Alternatively, if Bᵢ were proposed in a Normal Proposal N and Bⱼ in a Fallback Recovery Proposal F, or vice-versa, then the Vote Rule allows honest peers to vote for both blocks. However, since the well-formedness rule for Fallback Recovery Proposals requires that F be justified by TCᵣ₋₁, by Lemma 1, N. B will never be certified. Therefore, Bᵢ=Bⱼ.

Lemma 3 (LDC implies GL). If B is LDC by an honest process the node then B is GL.

Suppose the node LDC B and let r=B·r. By Definition 4, the node must have observed QCs for B and B′ such that B′·r=r+1 and B⇐=B′. Furthermore, since B′ is certified, at least f+1 honest peers must have voted for B′ in r+2. It is impossible for any valid Fallback Recovery Proposal F for r+1 to have B as its parent since TCᵣ, by which F must be justified, is only well-formed if it includes QCs for rounds less than r.

Therefore, B′ must be a Normal Proposal. Therefore, the Normal Vote Rule ensures that the f+1 honest peers that voted for B′ must have locked the QC for B whilst in r+1 and before sending Tᵣ. Thus, by Definition 6, B is GL.

Lemma 4 (Max Observed QC≥Locked QC). If the node is an honest process then the node always has maxQC(U)·r≥qcₗ·r

Proof: Recall that if the node observes QCᵣ and has not previously seen a QC for round r, then it adds QCᵣ to U. Therefore, since the node must observe a QC in order to lock it, if the node never removes qcl from U then has maxQC(U)·r≥qcₗ·r. Additionally, recall that the commit function only allows the node to remove QCᵣ from U when it appends Bᵣ′ to Bv such that r′>r. Consequently, since the node may only execute the commit function with QCᵣ when it observes that Bᵣ is LDC, Definition 4 implies that the node must have observed QCᵣ₊₁, which it must have added to U. Thus maxQC(U)·r≥qcₗ·r.

Lemma 5 (LDC is Unique). If B is LDC then for every certified block B′ with B′·r≥B·r, B⇐*B′.

This claim is proven by induction on the round number. Lemma 2 proves that if B′·r=B·r then B′=B and thus B⇐*B′. Consider the case when B′·r>B·r:

Base Case: B′·r=B·r+1. Once again, Lemma 2 proves that only one block can become certified in a given round. Therefore, because B′ is certified for B·r+1 and B is LDC, it follows from Definition 4 that B⇐B′.

Inductive Step: Assume that the lemma holds up to Bₖ such that Bₖ·r>B·r and complete the proof for B′·r=Bₖ·r+1.

If Bₖ⇐B′ then, by the Induction Hypothesis, B⇐*B′. Therefore, the only case that remains is when B″⇐B′ such that B″·r<B·r. Recall that the Normal Vote Rule only allows honest processes to vote for a Normal Proposal for round r if its parent was proposed for r−1. Therefore because B′ is certified and since B″·r<B·r<B′·r−1, B′ must have been proposed as a Fallback Recovery Proposal. Recall that the Fallback Vote Rule ensures that a process will only consider Fallback Recovery Proposal F for round r valid if it contains a valid TCᵣ₋₁ and the parent of F. B is certified by the QC with the maximum round number included in that TCᵣ₋₁. Let r=B·r. Recall that Lemma 3 proves that since B is LDC, it is also GL. Furthermore, by Definition 6, B being GL guarantees that at least f+1 honest processes locked B whilst in r+1. Therefore, since the well-formedness rule for Timeout messages requires a process to include the highest QC that it has observed, i.e. maxQC(U), when it sends a Timeout message, Lemma 4 implies that any Timeout message for r+1 or greater sent by these f+1 honest processes will contain a QC for round r or higher. Therefore, because there are only 2f+1 honest processes, n=3f+1 and TCs must be constructed from at least 2f+1 Timeout messages, every TC for r+1 or greater must contain a QC for round r or higher. Therefore, since B′·r>r+1 and because B′ is necessarily a Fallback Recovery Proposal, B″·r≥r, contradicting the earlier conclusion that B″·r<B·r. Thus B⇐*B′.

Therefore, B⇐*B′ for every certified block B′ such that B′·r≥B·r. Corollary 1 follows from Lemma 5 and the fact that every LDC block is necessarily certified. Corollary 1 (Consistency). If B and B′ are both LDC then either B⇐*B′ or B′⇐*B

Theorem 1 (Safety). For every run R∈RP, for each pair of honest processes (vᵢ, vⱼ)∈V×V, at each moment during R either Bᵥ_{ᵢ}≤Bᵥ_{ⱼ} or Bᵥ_{ⱼ}≤Bᵥ_{ᵢ}.

Let

$${B}_{{v}_{i}} = {B}_{0}^{1} {⇐}^{*} {B}_{s}^{1} and {B}_{{v}_{j}} = {B}_{0}^{2} {⇐}^{*} {B}_{t}^{2} .$$

Then for every height 0≤l≤s, it follows that vᵢLC

$${B}_{l}^{1}$$

and for every height 0≤h≤t, vⱼLC

$${B}_{h}^{2} .$$

Therefore, from Definition 5,

$${B}_{s}^{1} and {B}_{𝔱}^{2}$$

are LDC. Therefore, from Corollary 1 it is shown that

$${B}_{s}^{1} {⇐}^{*} {B}_{t}^{2} or {B}_{t}^{2} {⇐}^{*} {B}_{s}^{1} .$$

Thus, either Bᵥ_{ᵢ}≤Bᵥ_{ⱼ} or Bᵥ_{ⱼ}≤Bᵥ_{ᵢ} at every moment of every R∈ [symbol] .

Note here that an assumption of perfect communication channels implies that all messages between the processes in V are eventually delivered. Moreover, since there is an assumption that these channels are partially synchronous, the upper bound on this delivery during each synchronous period during the protocol run is Δ. For the sake of the following proofs, it is reasoned in the context of one such synchronous period, the beginning of which are denoted alternatively by either GST or t_{g}. These assumptions and definitions are carried forward in the following proofs. All honest peers are guaranteed to continue to enter new rounds after GST.

Lemma 6 (Round Sync). Let r be the highest round of any honest process at time t≥t_{g}. All honest peers enter r or greater before t+2Δ.

Proof: Let the node be a process in r at t. Recall that the Round Transition Rules allow a process to enter round only if it observes QCᵣ₋₂ or TCᵣ₋₂. In the former case, the QC Sync Rule ensures that the node would have broadcasted QCᵣ₋₂ just before it entered r. Therefore, all honest peers will observe this certificate and enter r via the Normal Round Transition Rule before t+Δ, if they do not enter a higher round first.

In the latter case, the existence of TCᵣ₋₂ implies that at least f+1 honest peers must have broadcasted Tᵣ₋₂ before observing QCᵣ₋₂. Consequently, because all honest peers are guaranteed to observe these messages before t+Δ, if any of them observed QCᵣ₋₂ before this time then, as previously reasoned, they would all enter r before t+2Δ. Alternatively, if no honest process had observed QCᵣ₋₂ before t+Δ and none of those that had yet to send Tᵣ₋₂ had garbage collected r−2 before this time, then they would have sent Tᵣ₋₂ messages of their own. Therefore, all processes would be able to construct TCᵣ₋₂ before t+2Δ.

Suppose, then, that some honest process v′ had garbage collected r−2 before t+Δ but had not sent Tᵣ₋₂. Therefore, by the Garbage Collection Rule, v′ must have spent at least 5Δ in some round r′≥r before t+Δ. However, this implies that v′ entered r′ no later than t−4Δ, contradicting the definition of r as being the highest round of any honest process at t if r′>r. Therefore, r′=r. Furthermore, v′ cannot have entered r via TCᵣ₋₂, otherwise the Timeout Sync Rule would have caused it to broadcast Tᵣ₋₂, contradicting the assumption that it does not do so. Therefore, v′ must have entered r via QCᵣ₋₂, which the QC Sync Rule once again ensures all honest processes will observe before t+Δ.

Lemma 7 (Honest Majority Advances Sequentially). No honest node can enter r′≥r until at least f+1 honest peers enter r−1.

Proof: As mentioned, the Round Transition Rules require a process to observe either QC_{r′-2} or TC_{r′-2} before it enters r′. Therefore, since QCs and TCs both require 2f+1 votes and because the Vote and Timeout Rules only allow processes to send Prepare or Timeout messages for r′−2 once they are in r′−1, no honest process can enter r until at least f+1 honest peers enter r−1. Therefore, since no honest process can enter r until this event, by the same reasoning, neither can any enter a round after r.

Lemma 8 (TC Bound). Let r be the highest round of any honest process at time t≥t_{g}. If any process ever observes TCᵣ₋₁, then every honest process does so before t+5Δ+τ.

Recall that the existence of TCᵣ₋₁ implies that at least f+1 honest peers sent Tᵣ₋₁, which the Timeout and Timeout Sync Rule together ensure can only occur after at least one honest process has spent T in r. Furthermore, recall that Lemma 6 proves that all honest peers are guaranteed to enter r or greater before t+2Δ. Therefore, the Timeout and Timeout Extension Rules together ensure that the f+1 honest peers that sent the Tᵣ₋₁ messages used to construct TCᵣ₋₁ must have sent these messages before t+3Δ+τ. Consequently, the Timeout Sync Rule ensures that if the remaining honest peers had not garbage collected r−1 before receiving these messages then they would have sent Tᵣ₋₁ messages of their own no later than t+4Δ+τ, so all processes will be able to construct TCᵣ₋₁ no later than t+5Δ+τ.

Suppose, then, that some honest node v′ garbage collected r−1 before observing these messages. Therefore, by the Garbage Collection Rule, v′ must have spent at least 5Δ in r′>r before t+4Δ+τ. However, this contradicts the definition of r as being the highest round of any process at t, so v′ cannot have garbage collected r−1.

Lemma 9 (Certificate Forms). Let r be the highest round of any honest process at time t≥t_{g}. All honest peers observe a certificate for r′≥r−1 before t+4Δ+τ.

Proof: Lemma 6 proves that all honest peers enter r or greater within t+2Δ. Therefore, the Timeout and Timeout Extension Rules together ensure that if all honest peers remain in r until t+3Δ+τ then they will all broadcast Tᵣ₋₁ messages at this time. Therefore, even if the Byzantine processes remain silent, all processes will still be able to construct TCᵣ₋₁ and enter r+1 via the Fallback Round Transition Rule before t+4Δ+τ.

Suppose, then, that some honest process v′ advanced to rₕ>r before sending Tᵣ₋₁ and thus before t+3Δ+τ. If rₕ=r+1 then v′ must have observed either QCᵣ₋₁ or TCᵣ₋₁. In the former case, the QC Sync Rule ensures that all honest peers will observe this QC and enter r+1 before t+4Δ+τ. In the latter case, the Timeout Sync Rule would have caused v′ to send Tᵣ₋₁, contradicting the assumption that it does not.

Alternatively, if r_h>r+1 then by Lemma 7, at least f+1 honest peers must have entered r+1 by either QCᵣ₋₁ or TCᵣ₋₁ before v′ entered rₕ and thus before t+3Δ+τ. Once again, the former case has already been covered. Furthermore, Lemma 8 proves that in the latter case, every honest process is guaranteed to observe TCᵣ₋₁ before t+5Δ+τ However, the upper bound on this observation only occurs when the adversary causes some honest peers to send Tᵣ₋₁ later than t+3Δ+τ by delivering QCᵣ₋₁ or higher to them just before this time, satisfying the premise.

From Lemma 9, Corollary 2 (Round Progress) is introduced. If

$$M > 4 + \frac{τ}{Δ}$$

then for every run R∈RP, for each synchronous interval S∈C_{R}(M), all honest peers continue to enter increasing rounds during S.

Using an assumption that M>4Δ+τ until discussing Theorem 2, it can now be shown that if an honest leader proposes a Fallback Recovery Proposal after GST then all honest peers will lock a QC for this proposal.

Corollary 3 follows from Lemma 8 and the Timeout Rule. Corollary 3 (TCᵣ₋₁ Before Tᵣ). If the first honest process enters r after GST and τ>5Δ, then if any process ever observes TCᵣ₋₁ then every honest process observes this TC before sending Tᵣ.

Lemma 10 (Honest Proposals Arrive Before Timeout). Let Lᵣ be honest and suppose GST had passed before the first honest process entered r. If Lᵣ proposes and τ>8Δ then all of its proposals reach all honest peers before the they send Tᵣ.

Proof: Let to be the time that the first honest process the node entered r. Suppose that Lᵣ creates a Fallback Recovery Proposal after observing TCᵣ₋₁. By the proof for Lemma 8, the latest that this can occur is just before t₀+τ+5Δ. Therefore, because Lᵣ is honest and will broadcast its proposal, every process will observe it before t₀+τ+6Δ. Furthermore, recall that the Timeout and Timeout Sync Rules together ensure that if any honest process sends Tᵣ then at least one honest process must have spent T in r+1. Therefore, in order for any honest process to have sent Tᵣ before observing Lᵣ's proposal, at least one honest process must have entered r+1 before t₀+6Δ. Therefore, by Lemma 6, all honest peers would have entered r+1 before t₀+8Δ. Hence, if τ>8Δ and some honest process sent Tᵣ then all honest peers would have entered r+1 before sending Tᵣ₋₁, meaning that Lᵣ could not have observed TCᵣ₋₁ and thus could not have proposed a Fallback Recovery Proposal. Thus, if Lᵣ proposes a Fallback Recovery Proposal and τ>8Δ then all honest peers will receive it before they send Tᵣ.

Alternatively, if Lᵣ instead created one or more Normal Proposals then the Normal Proposal Rule ensures that it would have done so strictly before creating any Fallback Recovery Proposal, therefore this case is subsumed by the prior reasoning.

Lemma 11 (Honest Fallback Proposals Succeed). Let Lᵣ be an honest leader and suppose that GST had passed before the first honest process entered r. If Lᵣ broadcasts a Fallback Recovery Proposal and τ>8Δ then all honest peers observe a QC for this proposal within τ+Δ of the first honest process entering r+1.

Proof: Lᵣ, being honest, would have sent the same well-formed Fallback Recovery Proposal F to all honest peers, and would only have created one such proposal. Recall that aside from its well-formedness, the validity of a Fallback Recovery Proposal relies only on the state of the af, rc, and E variables of its recipient. Also recall that Lemma 10 proves that if τ>8Δ then all honest peers will receive F before they send Tᵣ and thus before any process can enter r+2 via TCᵣ. Furthermore, by the premise, neither can any honest process have entered r+2 before this time by observing a QCᵣ for F, otherwise the proof would be complete. Moreover, since F is necessarily justified by TCᵣ₋₁, Lemma 1 proves that neither can any honest process have entered r+2 by observing a QCᵣ for a Normal Proposal made by Lᵣ. Thus, by Lemma 7, no honest process can have entered r″>r+1 before receiving F. Consequently, every honest process will have r_{c}≤r+1 and rᵥ≤r upon its arrival and will enter r+1, if they have not already done so, upon processing TCᵣ₋₁. Therefore, if τ>8Δ then the Fallback Vote Rule guarantees that all honest peers will vote for F before they send Tᵣ. Therefore, all honest peers will observe a QC for F within τ+Δ of the first honest process entering r+1.

Lemma 12 (Honest Fallback Proposals Are Locked). Let Lᵣ be an honest leader and suppose that GST had passed before the first honest process entered r. If Lᵣ broadcasts a Fallback Recovery Proposal, then all honest peers lock a QC for this proposal.

Proof: Let F denote Lᵣ's Fallback Recovery Proposal justified by TCᵣ₋₁. Lemma 11 proves that if τ>8Δ then all honest peers observe a QC for F within τ+Δ of the first honest process entering r+1.

Furthermore, by Corollary 3, all honest peers will observe TCᵣ₋₁ before sending Tᵣ and thus the Fallback Extension Rule ensures that they will all increase the length of their respective round timers for r to τ+Δ. Therefore, all honest peers will observe a QC for F before sending Tᵣ. Consequently, TCᵣ cannot exist before all honest peers observe QCᵣ, so no honest process can have entered r′>r+1 before observing QCr. Thus, by the Lock Rule, all honest peers will lock QCᵣ.

The Timeout Extension Rule is an optimization that reduces the lower bound on τ from τ>9Δ to τ>8Δ. Notice that the proof for Lemma 10 shows that all honest peers will have entered r+1 before t₀+8Δ. Accordingly, if τ>9Δ then by the former reasoning, every honest process will observe a QC for Lᵣ's proposal before their round timers expire, enabling them to lock it. When L elects three consecutive honest leaders all honest peers are guaranteed to LDC the block proposed by the second leader.

Lemma 13 (Honest Leaders Propose). If the first honest process to enter r does so after GST, Lᵣ is honest and τ>2Δ, then Lᵣ proposes.

Proof: Suppose that Lᵣ does not propose. Therefore, QCᵣ will never exist so no honest process can ever enter r+2 via this certificate. However, recall from Corollary 2 that all honest peers continue to enter increasing rounds after GST. Therefore, Lemma 7 implies that at least f+1 honest peers must eventually enter r+2 via TCᵣ. However, the Timeout and Timeout Sync Rules together ensure that TCᵣ cannot exist until at least one honest process has spent τ in r+1. Let the node be the first honest process to send Tᵣ and let the time that the node enters r+1 be denoted tv. Therefore, since QCᵣ cannot exist and because TC r cannot exist before tᵥ+τ, these two facts along with Lemma 7 imply that no honest process can have entered r′>r+1 before tᵥ+τ. Therefore, since Lemma 6 proves that all honest peers including Lᵣ will enter r+1 no later than tᵥ+2Δ, if τ>2Δ and Lᵣ does not propose then Lᵣ must enter r+1. However, if Lᵣ enters r+1 via QCᵣ₋₁ then the QC Extension Rule ensures that it will create a Normal Proposal extending the block certified by QCᵣ₋₁, contradicting the assumption that it does not propose. Similarly, if Lᵣ enters r+1 via TCᵣ₋₁, then it will instead create a Fallback Recovery proposal extending the block certified by the QC with the greatest round included in TCᵣ₋₁, once again contradicting the initial assumption. Therefore, if τ>2Δ, the first honest process to enter r does so after GST and Ly is honest, then Lᵣ proposes.

Lemma 14 (Locking). Let Lᵣ and Lᵣ₊₁ be consecutive honest leaders and suppose that GST had passed before the first honest process entered r. If τ>8Δ then all honest peers lock a QC for the proposal of Lᵣ₊₁.

Fallback Recovery. Suppose Lᵣ₊₁ sends a Fallback Recovery Proposal F. Therefore, because τ>8Δ, Lemma 12 proves that all honest peers lock a QC for F_{B}.

Normal. Suppose Lᵣ₊₁ sends a Normal proposal N. Therefore, Lᵣ₊₁ must have either received a valid proposal containing Br from Lᵣ or must have entered r+2 via QCᵣ before receiving the corresponding proposal. Therefore, since Lᵣ was honest and would have broadcasted its proposal, Lemma 10 proves that Bᵣ will reach all processes within T of the first honest process entering r+1 and thus before any honest process broadcasts Tᵣ. Consider the type of Lᵣ's proposal.

Fallback Recovery. Suppose Lᵣ sent a Fallback Recovery Proposal. Therefore, since Lemma 10 proves that Lᵣ₊₁ will receive this proposal before broadcasting Tᵣ, the Fallback Recovery Proposal Processing Rule ensures that it will propose the Normal Proposal Bᵣ⇐=Bᵣ₊₁. Lemma 10 once again proves that all honest peers will receive this proposal before they send Tᵣ₊₁. Furthermore, Lemma 12 proves that all honest peers will lock a QC for Lᵣ's proposal, meaning that all honest peers will vote for N once in r+2.

Normal. Suppose Lᵣ sent a Normal Proposal.

Let t₁ denote the time that the first honest process entered r+1. If all honest peers locked QCᵣ₋₁ due to receiving it before sending Tᵣ₋₁ then Lemma 6 proves that they must all have entered r+1 within 2Δ of each other.

Furthermore, Lᵣ would have broadcasted its related Normal Proposal no later than the time that it observed QCᵣ₋₁, so all honest peers would have observed both QCᵣ₋₁ and Bᵣ before t₁+3Δ and thus would have voted for Bᵣ. Importantly, although Lᵣ is permitted to create multiple Normal Proposals, the Proposal Rules ensure that it would only have created one that extended the block certified by QCᵣ₋₁, meaning that all honest peers would have voted for the same Bᵣ. Therefore, all processes would have observed QCᵣ before t₁+4Δ and because τ>8Δ, they would all have locked this QC. Furthermore, since Lᵣ₊₁ would also have created its proposal of Bᵣ⇐=Bᵣ₊₁ no later than the time that it voted for Bᵣ, all processes would have received it before t₁+4Δ and thus would have been able to vote for it after entering r+2 via QCᵣ. Since no honest process can have entered r+2 before t₁ and because all honest peers will observe QCᵣ₊₁ before t₁+5Δ, the fact that τ>84 implies that all honest peers will lock QCᵣ₊₁.

Alternatively, if even one honest process did not lock QCᵣ₋₁ then it is possible for Lᵣ's Normal Proposal to fail to achieve a QC without Lᵣ ever proposing a Fallback Recovery Proposal. This occurs when the adversary controls QCᵣ₋₁ due to having prevented at least one honest process from voting for Bᵣ₋₁, and subsequently delivers this QC to at least one honest process before it sends Tᵣ₋₁ while ensuring that the remainder receive it after sending Tᵣ₋₁. In this case, if the Byzantine processes do not send Tᵣ₋₁ messages, then TCᵣ₋₁ will never exist, preventing Ly from creating a Fallback Recovery Proposal. Therefore, all honest peers will eventually enter r+1 via QCᵣ₋₁, where at least one of them will be unable to vote for Bᵣ. However, if the adversary causes Lᵣ to fail to produce a certified proposal, then Corollary 2 implies that all honest peers will inevitably observe TCᵣ. Therefore, Lᵣ₊₁ will propose a Fallback Recovery Proposal, the proof for which case has already been covered. Therefore, in both cases, if τ>84 all honest peers will lock Lᵣ₊₁'s proposal.

Lemma 15 (All LDC: Three Honest Leaders). Let Ly, Lᵣ₊₁ and Lᵣ₊₂ be consecutive honest leaders and suppose GST had passed before the first honest process entered r. All honest peers LDC the proposal of Lᵣ₊₁.

Proof: Lemma 14 proves that if τ>8Δ then all honest peers lock a QC for r+1 before entering r+3. Repeated application of this lemma for Lᵣ₊₁ and Lᵣ₊₂ shows that they will do the same for a QC for r+2 before entering r+4. Furthermore, because all honest peers lock QCᵣ₊₂ Lemma 1 implies that TCᵣ₊₁ cannot exist. Therefore, the QCᵣ₊₂ locked by all honest peers must be for a Normal Proposal, which the Vote Rule for Normal Proposals ensures must be a child of the block proposed by Lᵣ₊₁. Therefore, all honest peers are guaranteed to execute the Commit Rule on the same proposal from Lᵣ₊₁ upon locking QCᵣ₊₂.

Lemma 15 is sufficient to allow us to complete the proof for Theorem 2. However, Chained Moonshot is guaranteed to LDC honest blocks under other circum-stances as well. To properly understand the round liveness properties of Chained Moonshot, several more lemmas are presented before completing the proof. This also allows us to make our bound on c, which indicates the minimum duration of network synchrony that a blockchain-based SMR protocol can tolerate whilst still achieving the Liveness property, tight.

Lemma 16 (Canonical Progress). Let Lᵣ be an honest leader and suppose that GST had passed before the first honest process entered r. The first certified block, say B′, that has B′·r>r, extends either B′·r>r, extends either Bᵣ₋₁ or Bᵣ.

Let r′=B′·r. If B′ were proposed as a Normal Proposal then by the Normal Vote Rule, r′=r+1 and B_r⇐B′. Suppose, then, that B′ was proposed as a Fallback Recovery Proposal.

Lemma 13 proves that Lᵣ will propose. Consider the type of this proposal.

Fallback Recovery. Suppose Lᵣ sends a Fallback Recovery Proposal containing Bᵣ. Lemma 12 proves that if τ>8Δ then all honest peers lock a QC for Bᵣ. Therefore, the Lock and Normal Round Transition Rules together ensure that no honest process will ever send Tᵣ, so TCᵣ will never exist. Therefore, because B′ must be proposed as a Fallback Recovery Proposal and thus must be justified by a TC_{r′-1}, r′>r+1. Furthermore, since B′ is the first certified block for a round greater than r, TC_{r′-1} cannot contain greater QC than QCᵣ. Moreover, because all honest nodes will lock QCᵣ, which they can only do whilst in r+1, and because r′−1≥r+1, every honest T_{r′-1} message is guaranteed to contain the QC for Bᵣ. Consequently, TC_{r′-1} will necessarily include the QC for Bᵣ as its highest QC. Thus Bᵣ⇐B′.

Normal. Suppose Lᵣ sends a Normal proposal N. Therefore, Lᵣ must have either received a valid proposal containing Bᵣ₋₁ from Lᵣ₋₂, or must have entered r+1 via QCᵣ₋₁ without having seen the block certified by this QC.

In the latter case, since Lemma 7 and the assumption in the premise that the first honest process entered r after GST together ensure that Lᵣ's transition to r+1 must have happened after GST, the proof for Lemma 6 shows that all honest peers are guaranteed to observe QCᵣ₋₁ within Δ of Lᵣ entering r+1. Furthermore, since Lᵣ is honest and would have broadcasted its proposal, they are also guaranteed to observe its Normal Proposal containing Bᵣ₋₁⇐Bᵣ by the same time. Therefore, if all honest peers observe QCᵣ₋₁ before sending Tᵣ₋₁, then they will all lock this QC and thus will be able to vote for Bᵣ via the Normal Vote Rule once in r+1. If this happens, then since Lemma 6 proves that the Lᵣ cannot enter r+1 later than 2Δ after the first honest process does so, all honest peers will receive both By and QCᵣ₋₁ within 3Δ of the first honest process entering r+1. Thus, if τ>4Δ then all honest peers will lock QCᵣ. Consequently, because B′ must be proposed as a Fallback Recovery Proposal, as previously reasoned, r′>r+1 so the TC justifying B′ will necessarily include QCᵣ r as its highest QC. Thus Bᵣ⇐B′.

Alternatively, if even one honest process fails to lock QCᵣ₋₁ then Bᵣ might fail to become certified. If this occurs because Bᵣ₋₁ itself does not become certified and thus QCᵣ₋₁ does not exist, then all honest peers will eventually send Tᵣ₋₁ and thus Lᵣ will create a Fallback Recovery Proposal, the proof for which case has already been covered.

Suppose, then, that QCr−1 exists but QCr does not because at least one honest process fails to lock QCᵣ₋₁ and Lᵣ never creates a Fallback Recovery Proposal. Therefore, Lᵣ must not observe TCᵣ₋₁ whilst in r+1. This can only happen either if TCᵣ₋₁ does not exist, or if Lᵣ advances to rₕ>r+1 before observing this TC.

In the former case, Lemma 9 implies that all honest peers will observe QCᵣ₋₁ before tᵥ+4Δ+τ, where tᵥ denotes the time that the first honest process entered r. Consequently, since τ>8Δ and because no honest process can send Tᵣ until at least tᵥ+2τ, every honest process will observe QCᵣ₋₁ before sending Tᵣ. Furthermore, the rule for constructing Timeout messages ensures that if an honest process sends a Timeout message then that message includes the highest QC that the process has observed. Therefore, because B′ must be proposed as a Fallback Recovery Proposal and r′>r, TCᵣ is the lowest TC that could possibly justify B′. Furthermore, since B′ is the first certified block for a round greater than r and because it is have assumed that QCᵣ does not exist, no greater QC than QCᵣ₋₁ can exist, so the TC justifying B′ will necessarily include QCᵣ₋₁ as its highest QC. Thus Bᵣ₋₁⇐B′.

Alternatively, suppose that TCᵣ₋₁ exists but Lᵣ advances to rₕ>r+1 before observing it. Therefore, by Lemma 8, Lᵣ must enter rₕ before tᵥ+5Δ+τ. Furthermore, if τ>5Δ then it is impossible for TCᵣₕ₋₂ to exist before Lᵣ enters rₕ, so Lᵣ must have entered rₕ via QCᵣ₋₂. However, Lemma 1 proves that since TCᵣ₋₁ exists, QCᵣ cannot certify a Normal Proposal. In fact, since it is assumed that Lᵣ never creates a Fallback Recovery Proposal, QCᵣ cannot exist at all. Therefore, rₕ≠r+2. Furthermore, since Lemma 7 shows that at least f+1 honest peers must have entered rₕ−1, neither is it possible that rₕ>r+2. Thus, Lᵣ cannot have advanced to rₕ before observing TCᵣ₋₁.

Therefore, in both cases, either Bᵣ₋₁⇐B′ or Bᵣ⇐B′.

Lemma 17 (Normal Proposal Succeeds GL). If QCᵣ becomes Globally Locked and Bᵣ₊₁ becomes certified, then Bᵣ⇐Bᵣ₊₁.

Proof: By Definition 6, QCᵣ can only be GL if at least f+1 honest peers observe QCᵣ whilst in r+1 and before sending Tᵣ. Furthermore, since the Normal Round Transition Rule requires a process that observes QCᵣ to enter r+2 and because the Timeout and Timeout Sync Rules only allow a process to send Tᵣ whilst in r'≤r+1, if QCᵣ is GL then at most f honest peers will ever send Tᵣ. Therefore, TCᵣ cannot exist. Consequently, Bᵣ₊₁. cannot have been proposed as a Fallback Recovery Proposal and therefore must have been proposed as a Normal Proposal. Thus, by the Normal Vote Rule, Bᵣ⇐Bᵣ₊₁

Lemma 18 (All LDC: Bounds). If L is guaranteed to elect 2f+1 honest leaders every n rounds then all honest processes LDC at least f honest blocks and LC at least 2f+1 blocks, f+1 of which will be honest, every n rounds after GST.

Lemma 16 proves that for each honest leader, every subsequently certified block is a descendent of a block proposed by either that leader or its immediate predecessor. The successful block can be referred to as canonical. Furthermore, repeated application of Lemma 14 shows that any sequence of h≥2 honest leaders is guaranteed to produce h−1 canonical blocks.

Therefore, since L guarantees that there will be 2f+1 honest leaders every n rounds, at least 2f+1 blocks must become canonical. In the worst case, if the adversary arranges the Byzantine leaders such that f consecutive honest leaders are preceded by a Byzantine leader, then since each Byzantine leader can cause the proposal of its successor to fail to become certified, the 2f rounds with alternating Byzantine-then-honest leaders will fail to produce an LDC block. However, Lemma 16 still proves that these 2f rounds will produce at least f canonical blocks. Furthermore, since the remaining f+1 leaders are guaranteed to be honest and consecutive, Lemma 14 and Lemma 17 together imply that they will produce a further f+1 canonical blocks, f of which will be LDC. This accounts for the guaranteed f honest LDC blocks and 2f of the guaranteed 2f+1 LC blocks.

The outcome of the block proposed by the final honest leader, Lₑ, depends on what the adversary chooses to do with the first leader of the next n rounds. If the adversary allows Lₑ to be succeeded by another honest leader then, by Lemma 14, all honest processes will lock a QC for a block proposed by Lₑ₊₁. Therefore, since Lemma 17 shows that Bₑ⇐Bₑ₊₁, all honest processes will LDC Bₑ. The same occurs if the adversary instead causes Lₑ₊₁ to be Byzantine, but still facilitates QCₑ₊₁ in order to fail the proposal of Lₑ₊₂. Finally, if the adversary causes Lₑ₊₁ to be Byzantine and QCₑ₊₁ to fail, then Be will not be LDC. However, since Be is canonical the next block to become LDC will cause Bf to be LC. Assuming that the network remains synchronous, the former reasoning shows that this block is guaranteed to be proposed before round e+2f. Therefore, if L is guaranteed to elect 2f+1 honest leaders every n rounds then all honest peers LDC at least f honest blocks and LC at least 2f+1 blocks, f+1 of which will be honest, every n rounds after GST.

### Lemma 19 (All LDC: Five Leaders).

Let Lᵣ, Lᵣ₊₁ and Lᵣ₊₃, Lᵣ₊₄ be two pairs of consecutive honest leaders. Also, let Lᵣ₊₂ be Byzantine and suppose GST had passed before the first honest process entered r. All honest processes LDC at least one block proposed by one of the honest leaders.

Lemma 14 proves that all honest processes lock a QC for r+1 before entering r+3. Therefore, if the adversary causes Bᵣ₊₂ to become canonical, which implies that QCᵣ₊₂ is GL, then Lemma 17 shows that Bᵣ₊₁⇐Bᵣ₊₂. Thus, every honest process that observes both QCᵣ₊₁ and QCᵣ₊₂ will LDC Bᵣ₊₁. Alternatively, if the adversary causes Bᵣ₊₂ to fail, then Lemma 16 implies that Bᵣ₊₃ becomes canonical instead. Furthermore, since Lemma 14 proves that all honest processes will lock a QC for Bᵣ₊₄ and Lemma 17 proves that Bᵣ₊₃⇐Bᵣ₊₄, all honest processes will LDC Bᵣ₊₃.

Let τ=xΔ where x>8 and suppose M=cΔ. Recall also that Lemma 9 proves that all honest processes observe a QC for given round no later than 4Δ+τ after the first honest process enters it. Consequently, the upper bound on the length of any round is (x+4)Δ. Therefore, if u=x+4 then if c>uj+k|j>1, k>0 then Theorem 2 follows for all variants of Chained Moonshot that have: Leader election functions that satisfy the preconditions of either or both of Lemma 15 or Lemma 19, every j rounds and Block delivery protocols that guarantee that if any honest process observes a QC for some block B at time t then every honest process will receive B before t+kΔ.

Theorem 2 (Liveness). For every run R∈RP synchronous interval, for each synchronous interval S∈C_{R}(M), each honest process v∈V appends at least

$$⌊ \frac{\vert S \vert}{M} ⌋$$

new blocks proposed by honest leaders to its local blockchain Bᵥ during S.

Proof: Recall that CR(M)={S|S∈SR and |S|≥M} where M=cΔ. Therefore, since every S occurs after GST, and because |S|≥(uj+k)Δ where j>1 and k>0, Corollary 2 proves that all honest peers continue to enter increasing rounds during each S. Furthermore, since |S|≥(uj+k)Δ, every honest process is guaranteed to advance through at least j rounds during each period of synchrony during R. Consequently, because L guaranteed to elect either a sequence of at least three consecutive honest leaders or five consecutive leaders as described in the precondition of Lemma 19, every j rounds, Lemmas 15 and 18 guarantee that all honest peers will LDC at least one new block, say Bᵣ, whenever either of these events occurs.

Finally, since all in-transit messages are delivered upon GST and because every S occurs after GST, the lossless network and the QC Sync Rule together ensure that every honest process will have observed the QCs of all previously-certified blocks before scheduling Bᵣ for commit. Therefore, if QCs include the blocks themselves, then every honest process will append Bᵣ and its uncommitted ancestors to its local blockchain no later than the time that they observe the QC for Bᵣ₊₁ (i.e., when they LDC Bᵣ).

Alternatively, if QCs instead include the digest of the corresponding block then some honest peers may need to retrieve some blocks via the synchronization protocol discussed above in order to append it to Bv. However, recall that assuming that the protocol implementation incorporates a block delivery protocol that ensures that if any honest process observes a QC for some block B at time t then every honest process will receive B before t+kΔ. Therefore, since |S|≥(uj+k)Δ and because all honest peers must observe the QC for Bᵣ before u(j−1)Δ in order to lock it, which they must have done in order to vote for Bᵣ₊₁, they are all guaranteed to receive Bᵣ and by extension, all of its ancestors, during S and thus will append Bᵣ and its uncommitted ancestors to their respective local blockchains during S. blockchain Bv during S. Thus, each honest process the node ∈ the node appends at least └|S|┘ new blocks proposed by honest leaders to its local blockchain Bv during S.

By extension, if |S|=qM+r where q>0, r≥0, then each honest process v∈V will append at least q new blocks proposed by honest leaders to its local blockchain Bᵥ during S. Thus, each honest process v∈V appends at least

$$⌊ \frac{\vert S \vert}{M} ⌋$$

new blocks proposed by honest leaders to its local blockchain Bᵥ during S.

Chained Moonshot with a round-robin leader election function satisfies Theorem 2 for j=2f+3 when paired with a block delivery protocol that provides the aforementioned guarantee. Such a leader election function guarantees that every process is elected leader exactly once every n rounds, ensuring that at least 2f+1 out of every n leaders is honest. Consequently, since the adversary can prevent any block from becoming LDC for at most 2f+1 consecutive rounds, if each S∈CR(M) lasts long enough for all processes to learn the outcomes of 2f+3 consecutive rounds then either Lemma 15 or Lemma 19 will be satisfied at least once. Moreover, if the accompanying block delivery protocol is the block synchronization protocol above, then the implementation of Moonshot satisfies Theorem 2 for k=2.

Finally, the previously given value of M is over-approximate. It assumes that the network takes at least uΔ to decide on a value every round, but based on Lemma 18, at most f out of every n rounds can end with a TC. Consequently, a tighter bound on the required length of each S∈CR(M) may exist.

While various aspects and embodiments have been disclosed, other aspects and embodiments are contemplated. The various aspects and embodiments disclosed are for purposes of illustration and are not intended to be limiting, with the true scope and spirit being indicated by the claims in the non-provisional application claiming priority to this provisional application.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the methods and embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein. While various aspects and embodiments have been disclosed, other aspects and embodiments are contemplated. The various aspects and embodiments disclosed are for purposes of illustration and are not intended to be limiting.

What is claimed is:

1. A method comprising:
receiving a first proposed block in a first phase of a consensus protocol;
receiving a second proposed block in a second phase of the consensus protocol;
generating a prepare message including a vote on the first proposed block during the second phase of the consensus protocol;
receiving a third proposed block in a third phase of the consensus protocol;
generating a prepare message including a second vote on the second proposed block during the third phase of the consensus protocol; and
committing the first proposed block during the third phase of the consensus protocol.
